(19) United States
(12) Patent Application Publication
(10) Pub. No.: US 2025/0226602 A1
(43) Pub. Date: Jul. 10, 2025

(54) HIGH DENSITY, HIGH SPEED BOARD-TO-BOARD CONNECTORS

(71) Applicant: FCI Nantong Ltd., Nantong (CN)

(72) Inventors: Liqing Lei, Nantong (CN); Zelin Yao, Nantong (CN); Haoliang Sun, Nantong (CN); Shoukun Zhu, Nantong (CN)

(73) Assignee: FCI Nantong Ltd., Nantong (CN)

(21) Appl. No.: 19/006,789

(22) Filed: Dec. 31, 2024

(30) Foreign Application Priority Data
Jan. 4, 2024 (CN) 202410016044.7
Jan. 4, 2024 (CN) 202420022812.5

(51) Int. Cl. H01R 12/71; H01R 12/70

(52) U.S. Cl. CPC H01R 12/716; H01R 12/707

(57) ABSTRACT

High density, high speed board-to-board connectors include an array of terminals configured for signal transmission. In some embodiments, adjacent plug terminals have different heights so as to mate with respective receptacle terminals at different times and thereby distribute mating forces over time. In some embodiments, relatively tall plug terminals have curved intermediate portion that offset tails from mating ends so as to enable both reliable support for the relatively tall plug terminals with higher gravity centers and the use of the same footprint of connectors with relatively short plug terminals. In some embodiments, each receptacle terminal has a mating end with beams. Each beam has a flat portion and a curved portion helically extending from the flat portion and curving toward the curved portion of a respective beam. In some embodiments, a connector has a conductive member disposed to housing sides and configured for power transmission.

### CROSS-REFERENCE TO RELATED APPLICATIONS

This application claims priority to and the benefit of Chinese Patent Application Serial No. 202420022812.5, filed on Jan. 4, 2024. This application also claims priority to and the benefit of Chinese Patent Application Serial No. 202410016044.7, filed on Jan. 4, 2024. The contents of these applications are incorporated herein by reference in their entirety.

### TECHNICAL FIELD

This application relates generally to interconnection systems, such as those including electrical connectors, used to interconnect electronic assemblies.

### BACKGROUND

Electrical connectors are used in many electronic systems. It is generally easier and more cost effective to manufacture a system as separate electronic assemblies, such as printed circuit boards (“PCBs”), which may be joined together with electrical connectors. For example, board-to-board connectors connect two parallel PCBs in a stacking configuration. Conventional board-to-board connectors are typically designed with dual-row configurations, which, while common, impose limitations on their functionality and scalability. The restricted number of rows inherently limits the number of pins available, constraining the connector's capacity to support higher-density connections required in modern electronic systems.

### BRIEF SUMMARY

Aspects of the present disclosure relates to high density, high speed board-to-board connectors.

Some embodiments relate to a board-to-board connector. The board-to-board connector may comprise a housing comprising a base and a plurality of sidewalls extending above the base, the base comprising a plurality of channels extending therethrough, the plurality of channels disposed in an array of rows and columns; and a plurality of plug terminals held in respective channels of the plurality of channels, each of the plurality of plug terminals comprising a mating end extending above the base, a tail extending below the base and configured for surface mount soldering, and an intermediate portion joining the mating end and the tail and disposed inside a respective channel of the plurality of channels, wherein mating ends of plug terminals in a row extend above the base to a plurality of heights such that terminals of a mating receptacle connector engage with the plug terminals in the row at different times.

Optionally, mating ends of plug terminals in a column extend above the base to a same height.

Optionally, the mating ends of adjacent plug terminals in the row have different heights.

Optionally, the housing comprises a first sidewall extending in a column direction, and a second sidewall opposing the first sidewall in a row direction and extending in the column direction; the first sidewall comprises recessed portions on opposite ends in the column direction; and the second sidewall comprises protruding portions on opposite ends in the column direction.

Optionally, the plurality of channels are disposed in an array of at least three rows and at least three columns.

Optionally, each of the plurality of channels comprises a first portion adjacent a mating side surface of the base and having a first width in a row direction, and a second portion adjacent a mounting side surface of the base and having a second width in the row direction greater than the first width.

Some embodiments relate to an electronic system. The electronic system may comprise a first board-to-board connector described herein; and a second board-to-board connector fitting within the plurality of sidewalls of the first board-to-board connector.

Some embodiments relate to a board-to-board connector. The board-to-board connector may comprise a housing comprising a base and a plurality of sidewalls extending above the base, the base comprising a plurality of channels extending therethrough, the plurality of channels disposed in an array of rows and columns; and a plurality of plug terminals held in respective channels of the plurality of channels, each of the plurality of plug terminals comprising a mating end extending above the base, a tail extending below the base, and an intermediate portion joining the mating end and the tail and disposed inside a respective channel of the plurality of channels, the intermediate portion comprising a curved portion such that the mating end and the tail are offset from each other in a column direction.

Optionally, mating ends of the plurality of plug terminals in each column extend above the base to a same height; and mating ends of adjacent plug terminals in each row extend above the base to different heights.

Optionally, the tails are thinner than the intermediate portions.

Optionally, the board-to-board connector comprises a conductive member held by one or more of the plurality of sidewalls of the housing, the conductive member comprising a plurality of inner portions disposed on one or more inner surfaces of the one or more of the plurality of sidewalls and configured to mate with a conductive member of a mating receptacle connector, an outer portion disposed on one or more outer surfaces of the one or more of the plurality of sidewalls and configured to mount to a circuit board, and a connecting portion joining the plurality of inner portions and the outer portion.

Optionally, each of the plurality of inner portions comprises a frame, and a cantilever having a proximal end corrected to the frame and a distal end curving inwardly for contacting the conductive member of a mating receptacle connector.

Optionally, the distal end of the cantilever is disposed above the proximal end of the cantilever.

Optionally, the outer portion comprises a plurality of flat straight extensions configured to mount to the circuit board, and a plurality of curved portions disposed in alternative with the plurality of flat straight extensions and configured to mount to the circuit board.

Some embodiments relate to an electrical connector. The electrical connector may comprise a housing comprising a base comprising a plurality of channels extending therethrough, the plurality of channels disposed in an array of rows and columns; a plurality of terminals held in respective channels of the plurality of channels, each of the plurality of terminals comprising a mating end, a tail extending out of the base, and an intermediate portion joining the mating end and the tail; and a conductive member held by the housing, the conductive member comprises a plurality of flat straight extensions configured to mount to a circuit board, and a plurality of curved portions alternating with the plurality of flat straight extensions and configured to mount to the circuit board.

Optionally, the tails of the plurality of terminals comprise end surfaces configured for mounting to the circuit board; the plurality of flat straight extensions of the conductive member comprise end surfaces configured for mounting to the circuit board; the plurality of curved portions of the conductive member comprise end surfaces configured for mounting to the circuit board; and the end surfaces of the tails of the plurality of terminals, the plurality of flat straight extensions of the conductive member, and the plurality of curved portions of the conductive member are flush with each other.

Optionally, the conductive member comprises an outer portion disposed on one or more outer surfaces of the housing and comprising the plurality of flat straight extensions and the plurality of curved portions, and a plurality of inner portions disposed on one or more inner surfaces of the housing and configured to contact a conductive member of a mating connector.

Optionally, the base of the housing comprises a mating side surface having a plurality of recessed portions; and the conductive member comprises a housing engaging portion comprising a plurality of first tabs abutting the mating side surface of the base of the housing, and a plurality of second tabs disposed in respective recessed portions of the plurality of recessed portions of the mating side surface of the base of the housing.

Optionally, the mating end of each of the plurality of terminals comprises first and second beams; and each of the first and second beams comprises a flat portion extending from the intermediate portion, and a curved portion extending from the flat portion and curving toward the curved portion of an other one of the first and second beams.

Optionally, for each of the first and second beams: the curved portion extends from the flat portion in a respective helical direction gradually away from the flat portion.

These techniques may be used alone or in any suitable combination. The foregoing summaries are provided by way of illustration and are not intended to be limiting.

### BRIEF DESCRIPTION OF THE DRAWINGS

The accompanying drawings are not intended to be drawn to scale. In the drawings, identical or nearly identical components that are illustrated in various figures may be represented by a like numeral. For purposes of clarity, not every component may be labeled in every drawing. In the drawings:

FIG. 1A is a perspective view of a plug connector, showing a mounting interface, according to some embodiments.

FIG. 1B is a perspective view of the plug connector of FIG. 1A, showing a mating interface.

FIG. 2 is an exploded top perspective view of the plug connector of FIG. 1B.

FIG. 3A is a side view of the plug connector of FIG. 1A.

FIG. 3B is a cross-sectional view of the plug connector of FIG. 3A along a line marked “A-A” in FIG. 3A.

FIG. 3C is an enlarged view of a portion of the plug connector of FIG. 3B marked “M” in FIG. 3B.

FIG. 4 is a top perspective view of a plug housing of the plug connector of FIG. 2.

FIG. 5 is a top perspective view of an alternative embodiment of the plug housing of FIG. 4.

FIG. 6 is a perspective view of a plug terminal of a plug connector, according to some embodiments.

FIG. 7 is a perspective view of a plug terminal of a plug connector, according to some embodiments.

FIG. 8A is a top view of a plug connector having the plug housing of FIG. 5, according to some embodiments.

FIG. 8B is a cross-sectional view of the plug connector of FIG. 8A along a line marked “B-B” in FIG. 8A.

FIG. 8C is an enlarged view of a portion of the plug connector of FIG. 8B marked by “N” in FIG. 8B.

FIG. 9 is a top perspective view of a receptacle connector, showing a mating interface, according to some embodiments.

FIG. 10 is an exploded perspective view of the receptacle connector of FIG. 9.

FIG. 11A is a side view of the receptacle connector of FIG. 9.

FIG. 11B is a cross-sectional view of the receptacle connector of FIG. 11A along a line marked “C-C” in FIG. 11A.

FIG. 12 is a top perspective view of a receptacle connector, according to some embodiments.

FIG. 13 is a perspective view of a receptacle terminal of a receptacle connector, according to some embodiments.

FIG. 14 is a top perspective view of an electronic system, showing a plug connector and a receptacle connector mated with each other, according to some embodiments.

FIG. 15 illustrates a bottom perspective view of the electronic system of FIG. 14.

FIG. 16 illustrates a perspective view of the electronic system of FIG. 14, showing the plug connector and the receptacle connector separated from each other.

FIG. 17A is a side view of the electronic system of FIG. 14.

FIG. 17B is a cross-sectional view of the electronic system of FIG. 17A along a line marked “E-E” in FIG. 17A.

FIG. 18 is a cross-sectional view of the electronic system of FIG. 14 along a line marked “D-D” in FIG. 14.

FIG. 19 is a top plan view of the electronic system of FIG. 14.

FIG. 20 is an exploded perspective view of an electronic system, according to some embodiments.

FIG. 21 is a perspective view of a portion of the electronic system of FIG. 20, showing a plug connector mounted to a printed circuit board.

FIG. 22 is a perspective view of the electronic system of FIG. 21.

FIG. 23 is an exploded perspective view of the plug connector of the electronic system of FIG. 22.

FIG. 24 is a perspective view of a conductive member of the plug connector of FIG. 23.

FIG. 25 is a perspective view of a portion of the electronic system of FIG. 20, showing a receptacle connector mounted to a printed circuit board.

FIG. 26 is an exploded perspective view of the receptacle connector of the electronic system of FIG. 25.

FIG. 27 is a perspective view of a conductive member of the receptacle connector of FIG. 26.

FIG. 28A is a top plan view of the electronic system of FIG. 20.

FIG. 28B is a cross-sectional view of the electronic system of FIG. 28A along a line marked “F-F” in FIG. 28A.

FIG. 28C is an enlarged view of a portion of the electronic system of FIG. 28B marked “S” in FIG. 28B.

### DETAILED DESCRIPTION

The inventors have recognized and appreciated techniques for making high density, high speed board-to-board connectors. Board-to-board connectors connect two parallel PCBs in a stacking configuration. Techniques as described herein, for example, may provide high density and high speed board-to-board connectors that satisfy multiple design requirements. For example, techniques as described herein may provide a connector with more rows of terminals than a connector of conventional board-to-board design while having a comparable mating force. As another example, terminal designs as described herein may provide sufficient support to enable narrower terminals and/or to forego spacers between adjacent rows of conventional board-to-board designs. Further, techniques as described herein may provide a mounting face of a board-to-board connector that is sufficiently flat for mounting to a board even for board-to-board connectors that have relatively large physical dimensions, which contributes to a high terminal density. Such densities may enable simpler and more economical mounting of the connector in comparison to conventional board-to-board designs that may use complicated and expensive organizers. Further, techniques as described herein may have a relatively tall profile while still providing desired mechanical strength.

Board-to-board connectors described herein can have terminals disposed in a relatively high density and therefore support a relatively large number of terminals. Connectors described herein can be configured with a height, including relatively high profile. Connectors described herein can support both high speed signal transmission and power transmission.

According to aspects of the present disclosure, an electrical connector may comprise a housing having channels extending therethrough. The channels may be disposed in an array of rows and columns. Terminals configured for signal transmission may be held in respective channels. Each terminal may have a mating end configured to contact a mating terminal, a tail extending out of the housing configured to surface mount to a circuit board, and an intermediate portion joining the mating end and the tail. In some embodiments, a conductive member may be disposed along sides of the housing and configured for power transmission. The conductive member may include flat straight extensions configured to mount to the circuit board, and curved portions disposed in alternative with the flat straight extensions and configured to mount to the circuit board. The flat straight extensions of the conductive member may be tucked in pockets on the sides of the housing. The curved portions of the conductive member may be disposed between adjacent pockets on the sides of the housing.

In some embodiments, the terminals may be plug terminals. The mating ends of the plug terminals may extend above the base of the housing. In some embodiments, mating ends of adjacent plug terminals in each row may extend above the base to different heights so as to mate with respective receptacle terminals at different times and therefore distribute mating forces over time. In some embodiments, the plug terminals may be configured taller than conventional ones. Each tall plug terminal may have a curved intermediate portion that offset tails from mating ends so as to enable both reliable support for the tall plug terminals with higher gravity centers and the use of the same footprint of connectors with relatively short terminals.

In some embodiments, the conductive member may include an outer portion disposed on outer surface(s) of the housing, and multiple inner portions disposed on inner surface(s) of the housing. The outer portion may include the flat straight extensions and the curved portions for mounting to the circuit board. The inner portions may be configured to contact a conductive member of a mating connector. In some embodiments, each inner portion may include a frame, and a cantilever having a proximal end connected to the frame and a distal end curving inwardly for contacting a conductive member of a mating connector. For each cantilever, the distal end may be disposed above the proximal end. Each inner portion may include an extension extending from the frame downwardly and disposed in a receiving portion of the housing. In some embodiments, the terminals may be receptacle terminals. The mating ends of the receptacle terminals may be disposed in the channels. Each mating end of the receptacle terminal may include beams. Each beam may include a flat portion extending from the intermediate portion, and a curved portion extending from the flat portion and curving toward the curved portion of a respective beam so as to be capable of clamping to a plug terminal of a mating connector. In some embodiments, the curved portion may extend from the flat portion in a respective helical direction gradually away from the flat portion.

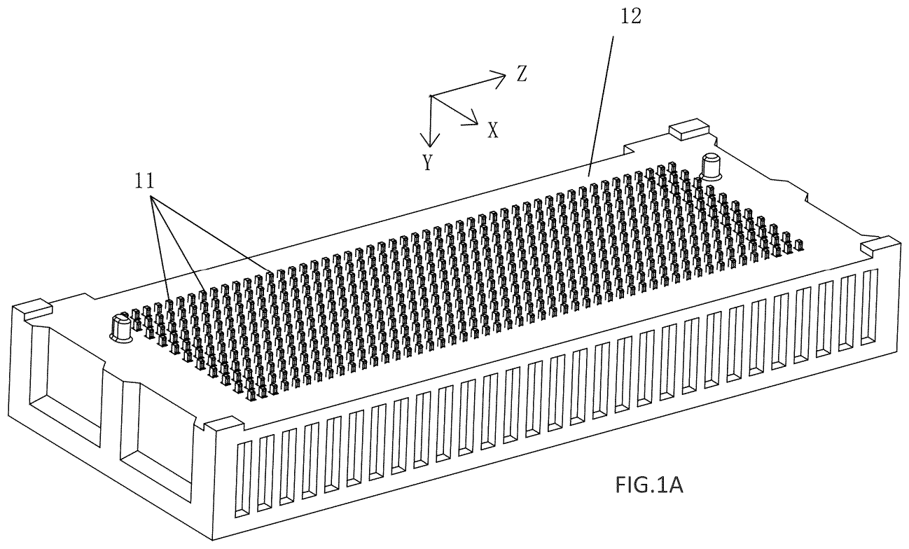

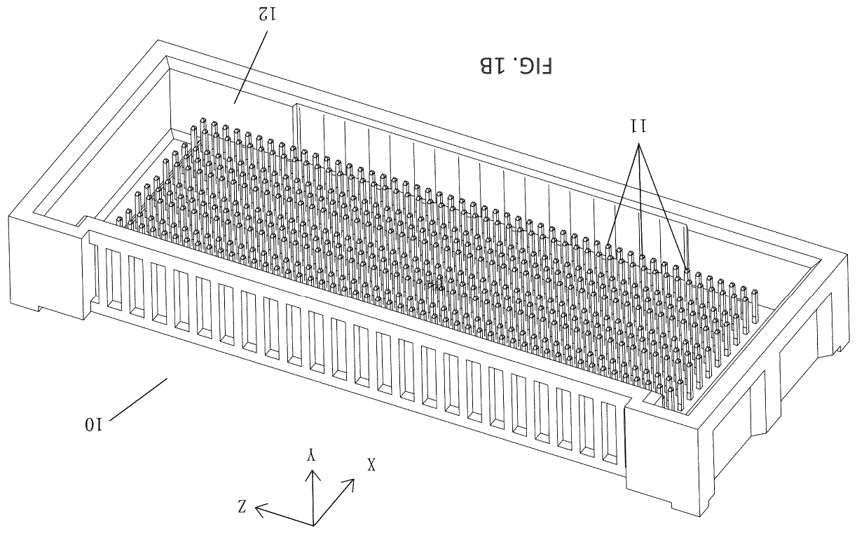

According to aspects of the present disclosure, a plug connector is provided. Referring to FIGS. 1A to 8C, in some embodiments, the plug connector 10 may include a thickness extending in a first direction Y; a width extending in a second direction X perpendicular to the first direction Y; and a length extending in a third direction Z perpendicular to both the first direction Y and the second direction X. The first direction Y may be referred to as a thickness direction or a height direction of the plug connector 10, the second direction X may be referred to as a width direction of the plug connector 10, and the third direction Z may be referred to as a length direction of the plug connector 10.

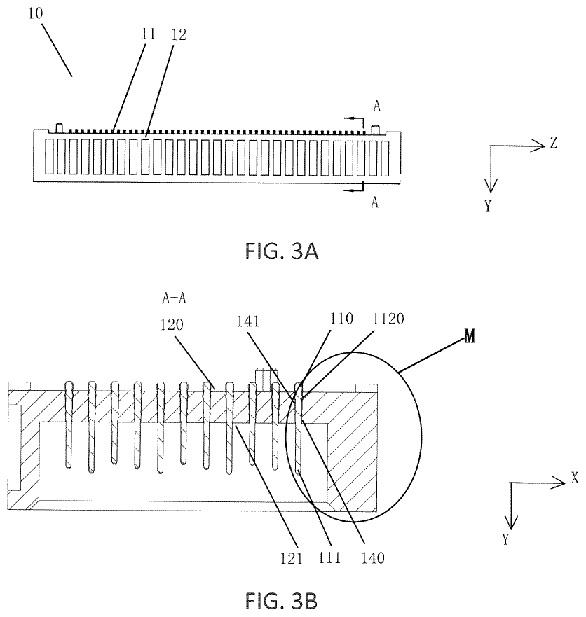

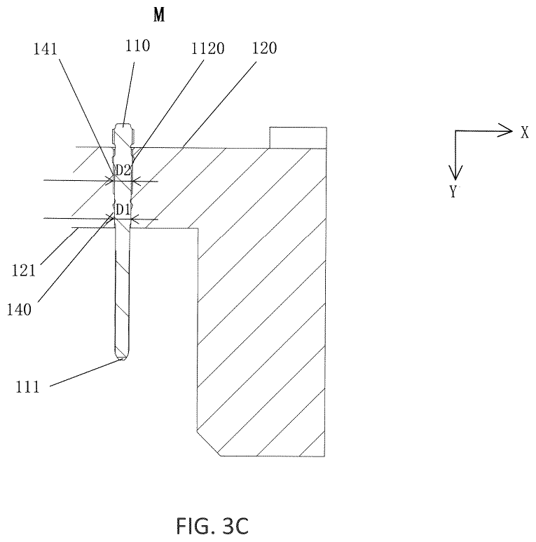

The plug connector 10 may comprise a plurality of plug terminals 11 arranged into an array of plug terminals, and a plug housing 12 for holding the plug terminals 11. In some embodiments, adjacent rows of plug terminals arranged in the second direction X and/or adjacent columns of plug terminals arranged in the third direction Z may have different heights from each other in the first direction Y of the plug connector 10. In some embodiments, as shown in FIG. 3B, adjacent rows of plug terminals 11 arranged in the second direction X have different heights from each other in the first direction Y.

In some embodiments, the array of plug terminals comprises at least three rows and/or at least three columns of plug terminals, and referring to FIGS. 1A and 1B, the plug terminals 11 arranged in the same rows or the same columns have the same height in the first direction Y, and the plug terminals in the array of plug terminals are arranged so as to have the same dimensions and configurations in every two rows or in every two columns, as shown by FIG. 3B.

In some embodiments, as shown in FIG. 3B, the first row of plug terminals 11 starting from the left side in the second direction X may have the same height as the fourth row of plug terminals 11 in the first direction Y; the second raw of plug terminals 11 starting from the left side in the second direction X may have the same height as the fifth row of plug terminals 11 in the first direction Y; and the third row of plug terminals starting from the left side in the second direction X may have the same height as the sixth row of plug terminals in the first direction Y.

In some embodiments, the plug terminals in the same row or column in the array of plug terminals may be otherwise arranged in a regular manner. In some embodiments, the plug terminals in the array of plug terminals may also be arranged such that every other row or every other column has the same dimension and configuration. Optionally, the plug terminals 11 in the array of plug terminals arranged in the same row or column may have different heights from each other in the first direction Y (not shown).

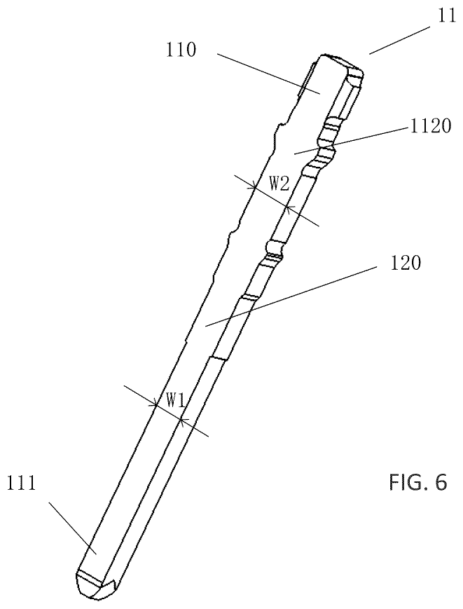

In some embodiments, as shown in FIG. 6, the plug terminal 11 may be shaped into a straight columnar member. In some embodiments, the plug terminal 11 may comprise a plug terminal tail 110, a plug terminal mating end 111, and an intermediate portion 112 connecting the plug terminal tail 110 to the plug terminal mating end 111. The plug terminal mating end 111 may have an outer contour dimension W1 in the second direction X less than an outer contour dimension W2 of the plug terminal tail 110 in the second direction X. Optionally, in some embodiments, the plug terminal mating end 111 may have an outer contour dimension in the third direction Z less than an outer contour dimension of the plug terminal tail 110 in the third direction Z (not shown).

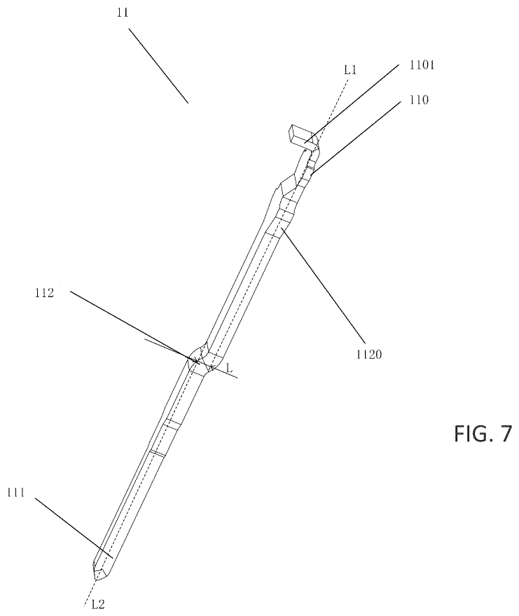

In some embodiments, as shown in FIG. 7, the plug terminal may be shaped into a curved columnar member. The plug terminal mating end 111 may have an outer contour dimension in the second direction X less than an outer contour dimension of the plug terminal tail 110 in the second direction X. Optionally, the plug terminal mating end 111 has an outer contour dimension in the third direction Z less than an outer contour dimension of the plug terminal tail 110 in the third direction Z.

In some embodiments, the straight plug terminal is suitable for cases where the plug connector has a smaller dimension in the first direction Y, and the curved plug terminal is suitable for cases where the plug connector has a larger dimension in the first direction Y. Alternatively, the straight plug terminal and the curved plug terminal may be used together in the plug connector, and the curved design of the intermediate portion of the curved plug terminal makes it possible to share the same printed circuit board with the straight plug terminal, thereby providing sufficient terminal strength for the plug connector.

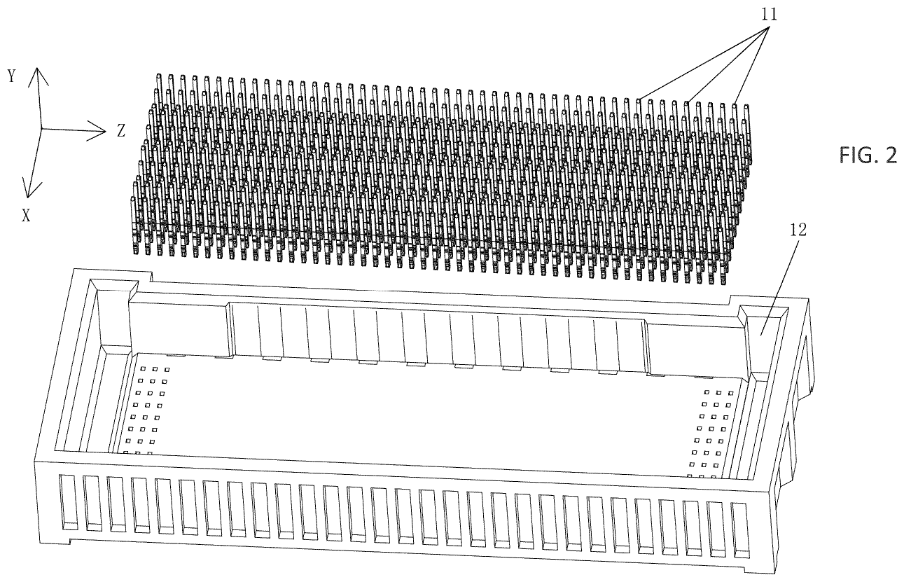

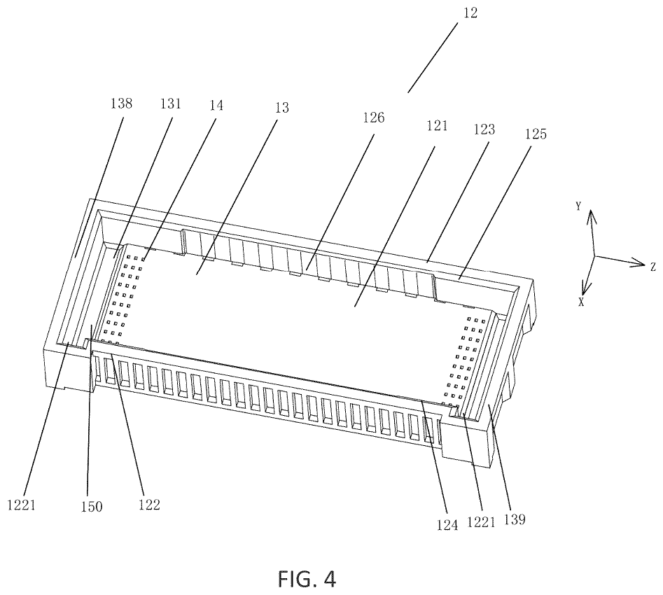

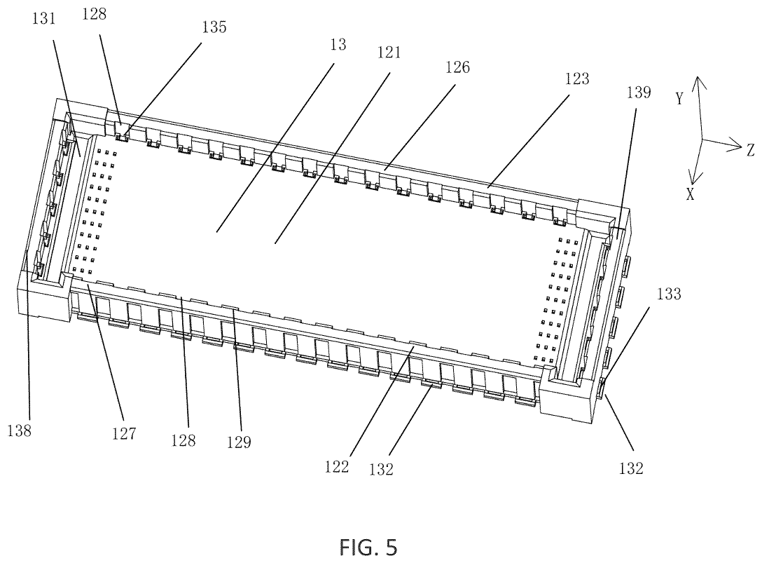

In some embodiments, as shown in FIGS. 4 and 5 and in conjunction with FIG. 3B, the plug housing 12 of the plug connector 10 may comprise a plug housing base 13. The plug housing base 13 may comprise a plurality of plug housing channels 14 arranged in an array as the same as the array of plug terminals. Each of the plug terminals 11 of the plug connector 10 may each extend through a corresponding one of the plurality of plug housing channels 14 such that a plug terminal mating end 111 of each of the plug terminals 11 extends beyond a mating side surface 121 of the plug housing base 13 and a plug terminal tail 110 of each of the plug terminals extends beyond a mounting side surface 120 of the plug housing base 13. The plug terminal mating end 111 extending beyond the mating side surface 121 of the plug housing base 13 is connected to the receptacle terminal, and the plug terminal tail 110 extending beyond the mounting side surface 120 of the plug housing base 13 is connected to the printed circuit board. For brevity, FIGS. 2, 4, and 5 may illustrate a portion of the plurality of plug housing channels. The plug terminal 11 passes through the plug housing channel 14 and is held by the plug housing 12.

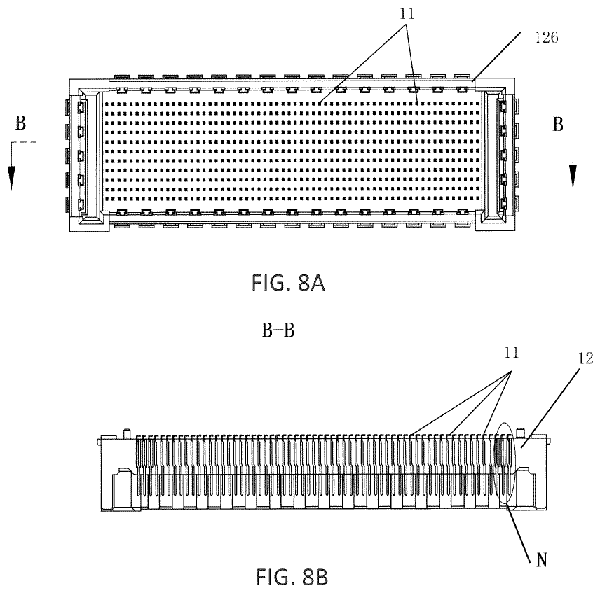

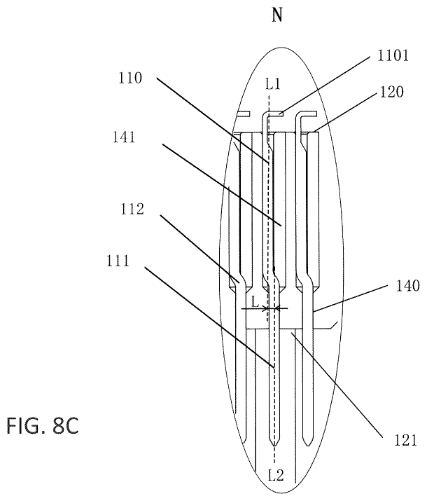

In some embodiments, as shown in FIGS. 3C and 8C, the plug housing channel 14 of the plug housing base 13 of the plug housing 12 of the plug connector 10 may comprise a plug housing channel first portion 140 for holding the plug terminal mating end 111 in a positive fit manner and a plug housing channel second portion 141 for holding the plug terminal tail 110 in a positive fit manner. The plug housing channel first portion 140 has a dimension D1 in the second direction X less than a dimension D2 of the plug housing channel second portion 141 in the second direction X. In some embodiments, the plug housing channel first portion 140 has a dimension in the third direction Z less than a dimension of the plug housing channel second portion 141 in the third direction Z. “A positive fit” may refer to a relationship in which two mating components are abutting and tightly fit with each other in terms of the shape and the position. The plug housing channel may securely hold the plug terminal.

In some embodiments, referring to FIGS. 6 and 7 and in conjunction with FIG. 3C, the plug terminal tail 110 may comprise at least one projection 1120 which extends in the second direction X and protrudes from opposite sides of the plug terminal tail 110 and which is provided adjacent to a proximal end of the plug terminal tail 110. The projection 1120 may be configured to be tapered from a side of the plug terminal tail toward a side of the plug terminal mating end in the first direction Y. When the plug terminal tail 110 is accommodated in the plug housing channel second portion 141, the projection 1120 abuts with opposing two inner side surfaces of the plug housing channel second portion 141 in the second direction X, forming an interference fit with the plug housing channel second portion 141, such that the plug terminal 11 can be stably received in the plug housing channel 14, and thus the plug terminal 11 is prevented from being accidentally pulled out of the plug housing channel 14.

In some embodiments, the intermediate portion 112 may comprise a curved portion (FIG. 7), and the curved portion may be configured to extend between the plug terminal tail 110 and the plug terminal mating end 111 such that a center axis L1 of the plug terminal tail 110 extending in the first direction Y and a center axis L2 of the plug terminal mating end 111 extending in the first direction Y are offset from each other by a certain distance L in the third direction Z. When the plug terminal 11 is accommodated in the plug housing channel 14, an outer side surface of the plug terminal tail 110 in the third direction Z away from the center axis L1 of the plug terminal tail 110 abuts against an inner side surface of the plug housing channel second portion 141 in the third direction Z (FIG. 8C). As a result, the plug housing channel second portion 141 can provide stable support for the plug terminal tail 110 such that the plug terminal 11 can be stably received in the plug housing channel 14. In some embodiments, the center axis L1 of the plug terminal tail 110 and the center axis L2 of the plug terminal mating end 111 are offset from each other in the third direction Z by a distance approximately equal to half of the difference between the dimension of the plug housing channel second portion 141 in the third direction Z and the dimension of the plug housing channel first portion 140 in the third direction Z.

In some embodiments, the curved portion of the intermediate portion 112 may be formed by deformation. The dimension from the intermediate portion to the plug terminal tail of each of the plurality of plug terminals may be configured to be consistent in order to ensure a consistent dimension of each plug terminal tail 110 extending beyond the mounting side surface 120 of the plug housing base 13.

In addition, it will also be appreciated by those skilled in the art that the curved portion of the intermediate portion 112 may also be used as a stopping portion so that: when the plug terminal 11 is inserted into the plug housing channel 14, the plug terminal tail 110, due to the curved portion, abuts against the inner surface of the plug housing channel second portion 141, thus preventing the plug terminal 11 from being excessively inserted into the plug housing channel 14, which in turn prevents the dimension that the plug terminal mating end 111 extends beyond the mating side surface 121 of the plug housing base 13 from exceeding a predetermined dimension, as shown in FIG. 8C.

Although in the illustrated embodiment, the projection 1120 is extended and protruded in the second direction X, and/or the center axis L1 of the plug terminal tail 110 and the center axis L2 of the plug terminal mating end 111 are offset from each other in the third direction Z, the projection 1120 may be configured to be extended and protruded in the third direction Z and/or the center axis L1 of the plug terminal tail 110 and the center axis L2 of the plug terminal mating end 111 are offset from each other in the second direction X. In addition, those skilled in the art would also understand that in the case where the plug terminal has the same configuration, the orientation of the arrangement of the plug terminals may be adjusted/changed to meet the needs of the use of different plug connectors. For example, based on the illustrated embodiment, each of the plug terminals in the array of plug terminals can be rotated 90 degrees or 180 degrees in a clockwise direction or in a counterclockwise direction, depending on requirements that different plug connectors are used.

In some embodiments, referring to FIGS. 4 and 5, the plug housing 12 of the plug connector 10 may comprise a plug housing sidewall 126 extending from an outer peripheral edge of the plug housing base 13 in the first direction Y. The plug housing sidewall 126 may be integrally formed with the plug housing base 13. The plug housing sidewall 126 may have a dimension in the first direction Y greater than a dimension of a portion of the plug terminal 14 that extends beyond a mating side surface 121 of the plug housing base 13.

In some embodiments, the plug housing sidewall 126 may be formed as a one-piece member with the plug housing base 13 by, for example, injection molding. The manufacturing process may be simple and allow the shape of the housing to be easily changed as needed to accommodate a variety of mounting requirements, enabling customized production required by a user to improve production flexibility and significantly reduce manufacturing costs.

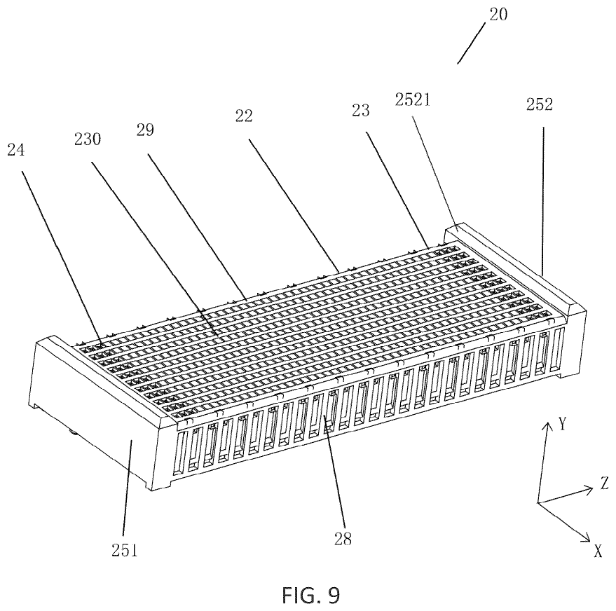

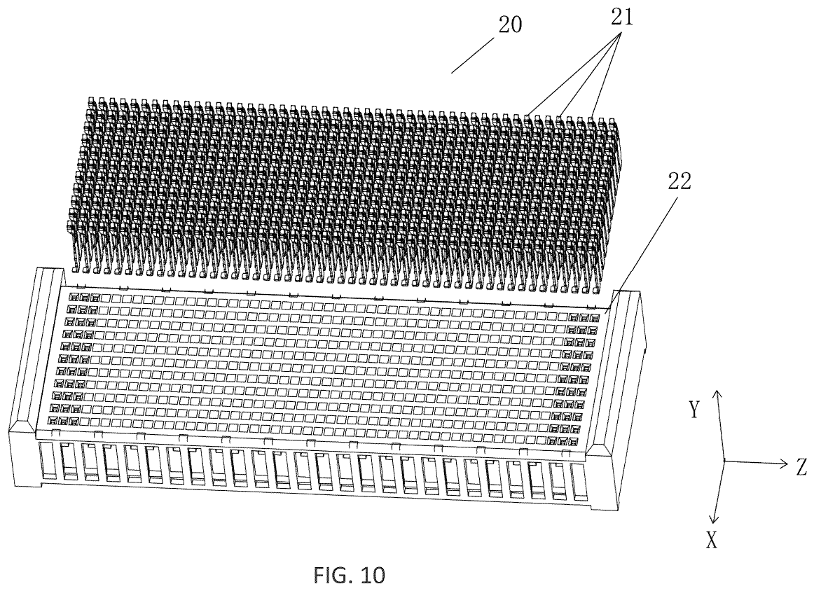

According to aspects of the present disclosure, a receptacle connector is provided. Referring to FIGS. 9 to 13, in some embodiments, a receptacle connector 20 may have a thickness (height) extending direction (e.g., a first direction Y); a width dimension (e.g., a second direction X perpendicular to the first direction Y); and a longitudinal extending direction perpendicular to both the first direction Y and the second direction X. The receptacle connector 20 may comprise a plurality of receptacle terminals 21 arranged into an array of receptacle terminals and a receptacle housing 22 for holding the receptacle terminal 21. The receptacle terminals 21 in the array of receptacle terminals may be arranged in rows in the second direction X and in columns in the third direction Z. The first direction Y of the receptacle connector may be referred to as a thickness direction or height direction of the receptacle connector, the second direction X of the receptacle connector may be referred to as a width direction of the receptacle connector, and the third direction Z of the receptacle connector may be referred to as a length direction of the receptacle connector.

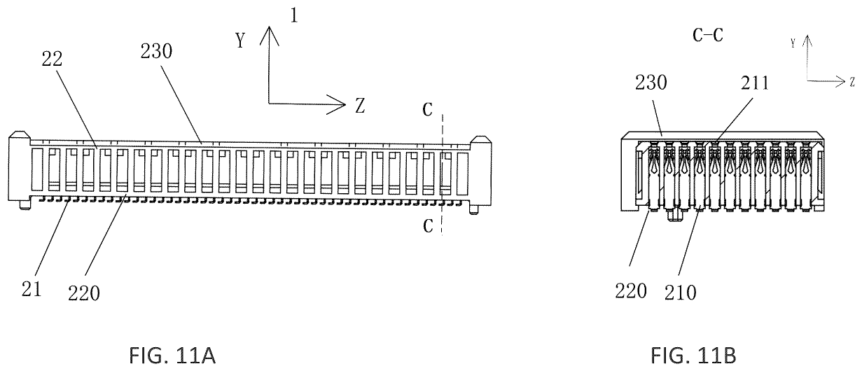

In some embodiments, referring to FIG. 11B, each of the plurality of receptacle terminals 21 may have the same dimensions in the first direction Y. This may facilitate the mating of the plug connector with the receptacle connector. Alternatively, in some embodiments, the receptacle terminals in the array of receptacle terminals arranged in the same row or column may have the same height in the first direction, and the receptacle terminals in adjacent rows or adjacent columns in the array of receptacle terminals may have different height in the first direction.

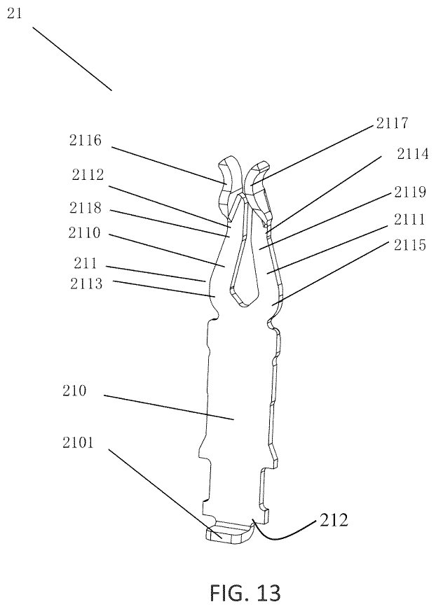

In some embodiments, referring to FIG. 13, the receptacle terminal 21 of the receptacle connector 20 may comprise a receptacle terminal intermediate portion 210 and a receptacle terminal mating end 211. The receptacle terminal intermediate portion 210 may be shaped into a plate-like portion to provide sufficient strength for the connection between the receptacle terminal and the printed circuit board and the connection between the receptacle terminal and the plug terminal. The receptacle terminal mating end 211 may comprise beams extending from the receptacle terminal intermediate portion 210. The beams may comprise a first beam 2110 and a second beam 2111. The first beam 2110 and the second beam 2111 may be formed such that they are spaced apart at a portion adjacent to the receptacle terminal intermediate portion 210 and are close to each other at a distal end away from the receptacle terminal intermediate portion 210 so as to form a clamping portion. When the plug connector is connected to the receptacle connector, the plug terminal mating end 111 of the plug terminal 11 is inserted into the clamping portion of the receptacle terminal, thereby forming an electrical connection.

In some embodiments, referring to FIG. 13, the first beam 2110 may comprise a first beam proximal portion 2113 adjacent to the receptacle terminal intermediate portion 210 and a first beam distal portion 2112 away from the receptacle terminal intermediate portion 210. The second beam 2111 may comprise a second beam proximal portion 2115 adjacent to the receptacle terminal intermediate portion 210 and a second beam distal portion 2114 away from the receptacle terminal intermediate portion 210. A distance between the first beam distal portion 2112 and the second beam distal portion 2114 may be less than a distance between the first beam proximal portion 2113 and the second beam proximal portion 2115. The distance between the first beam distal portion 2112 and the second beam distal portion 2114 may gradually increase when the plug terminal 11 of the plug connector 10 is inserted into the receptacle terminal of the receptacle connector 20, thereby providing a reliable stability for the connection between the plug connector and the receptacle connector.

In some embodiments, the first beam distal portion 2112 may comprise a first flat portion 2118 continuous with the first beam proximal portion 2113 and a first curved portion 2116 helically extending from the first flat portion 2118 in a first helical direction to gradually move away from the first flat portion 2118. The first flat portion 2118 may be in the same plane as the first proximal portion 2113. The first curved portion 2116 may be formed by twisting the first flat portion 2118 outwardly and upwardly. As can be seen in FIG. 13, the first helical portion 2116 may include a contact portion curving toward the second beam 2111.

In some embodiments, the second beam distal portion 2114 may comprise a second flat portion 2119 continuous with the second beam proximal portion 2115 and a second curved portion 2117 helically extending from the second flat portion 2119 in a second helical direction opposite to the first helical direction to gradually move away from the second flat portion 2119. The second flat portion 2119 may be in the same plane as the second proximal portion 2115. The second curved portion 2117 may be formed by twisting the second flat plate outwardly and upwardly. As can also be seen in FIG. 13, the second helical portion 2117 may include a contact portion curving toward the first beam 2110.

In some embodiments, the first curved portion 2116 and the second curved portion 2117 are configured to be spaced apart from each other and oriented toward each other. The first curved portion 2116 and the second curved portion 2117 may be spaced apart from each other at a distance less than the distance between the first beam proximal portion 2113 and the second beam proximal portion 2115 so as to form a clamping portion. When the plug terminal is inserted into the receptacle terminal, the plug terminal mating end 111 contacts the protrusion of the first curved portion 2116 and the protrusion of the second curved portion 2117 at the same time, thereby providing reliability for the connection of the plug connector 10 and the receptacle connector 20.

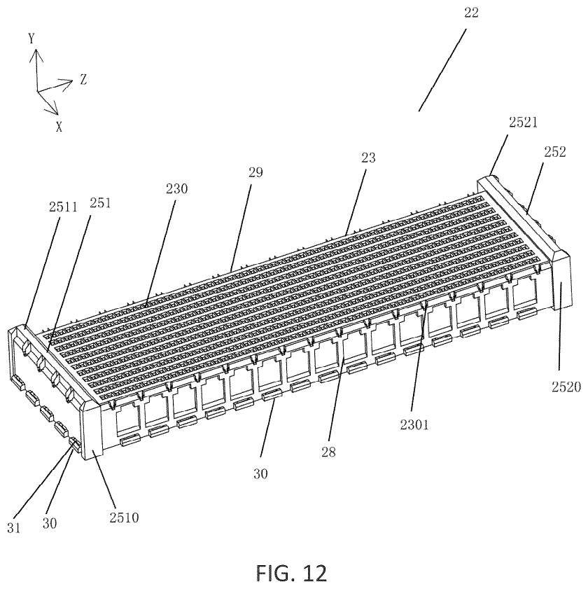

In some embodiments, referring to FIGS. 9 and 12 and in conjunction with FIG. 11B, the receptacle housing 22 of the receptacle connector 20 may comprise a receptacle housing base 23. The receptacle housing base 23 may comprise a plurality of receptacle housing channels 24 arranged into an array as the same as the array of receptacle terminals. Each receptacle terminal of the receptacle connector 20 is accommodated in a corresponding one of the plurality of receptacle housing channels 24, such that the receptacle terminal mating end 211 of each of the receptacle terminals 21 may not be visible from a mating side surface 230 of the receptacle housing base. The receptacle terminal tail 212 of each of the receptacle terminals 21 may extend beyond a mounting side surface 220 of the receptacle housing base 23. For brevity, FIG. 12 may illustrate a portion of the plurality of receptacle through-holes.

In some embodiments, as shown in FIG. 11B, the receptacle terminal mating end 211 of the receptacle terminal 21 is spaced apart from the mating side surface 230 of the receptacle housing base 23 such that the receptacle terminal mating end 211 of the receptacle terminal 21 may not be visible from the mating side surface 230 of the receptacle housing base, e.g., the receptacle terminal 21 is not visible when viewed outside of the receptacle connector 20.

Alternatively, the receptacle terminal of the receptacle connector may be configured to have other suitable shapes suitable for engagement with the plug terminal mating end of the plug receptacle. For example, in some embodiments, the receptacle terminal mating end for contacting the plug terminal mating end may be formed as a straight rod portion.

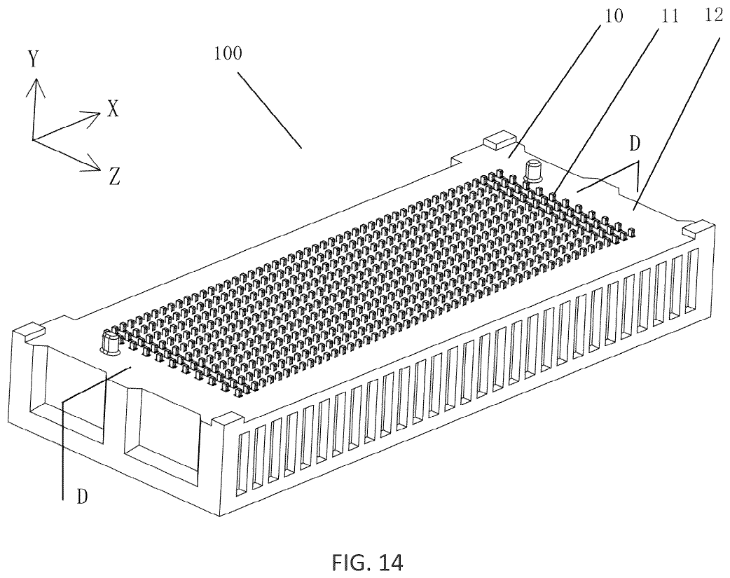

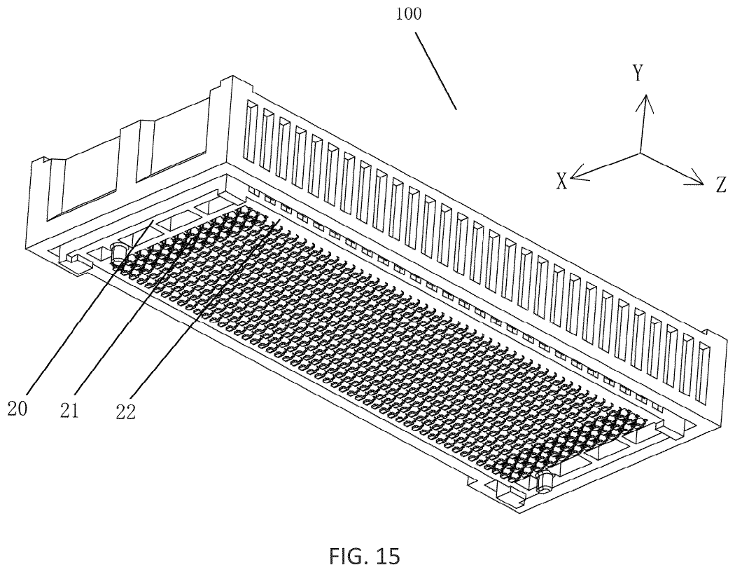

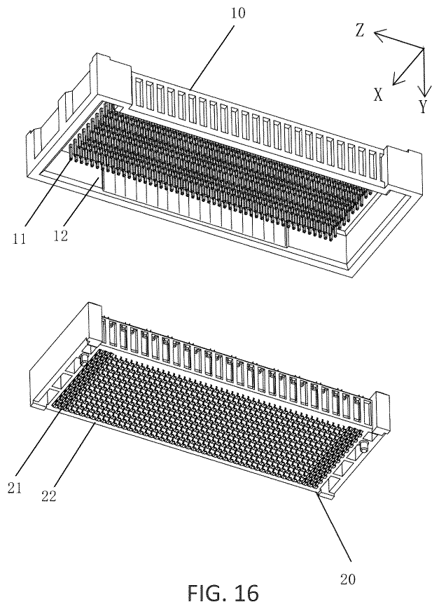

According to aspects of the present disclosure, an electronic system is provided. With reference to FIGS. 14 to 19, in some embodiments, an electronic system 100 may comprise a plug connector described herein (e.g., plug connector 10) and a receptacle connector described herein (e.g., receptacle connector 20) configured to mate with each other. In some embodiments, when the plug connector 10 and the receptacle connector 20 are engaged with each other, a mating side surface 121 of the plug housing base 13 and a mating side surface 230 of the receptacle housing base 23 face each other in a first direction Y, such that a plurality of plug terminals 11 arranged into an array of plug terminals are engaged with the plurality of receptacle terminals 21 arranged into an array of receptacle terminals in a one-to-one correspondence, so as to form an electrical connection.

When the plug connector 10 and the receptacle connector 20 are engaged with each other, a first direction of the plug connector (e.g., the thickness direction or the height direction of the plug connector) may be consistent with a first direction of the receptacle connector (e.g., the thickness direction or the height direction of the receptacle connector), and a second direction of the plug connector (e.g., the width direction of the plug connector) may be consistent with the second direction of the receptacle connector (e.g., the width direction of the receptacle connector), and the third direction of the plug connector (e.g., the length direction of the plug connector) may be consistent with the length direction of the receptacle connector (e.g., the length direction of the receptacle connector).

As described herein, adjacent rows or adjacent columns of the plug terminals in the array of plug terminals of the plug connector 10 may have different heights from each other in the first direction Y. As a result, force for connecting the plug connector 10 to the receptacle connector 20 and disconnecting the plug connector 10 from the receptacle connector can act on the plug terminals 11 at different times, so that connecting force/disconnecting force can be distributed throughout the entire process of connecting/disconnecting without generating a large force on the plug terminals at the same time, thus reducing the force to be exerted by a user when connecting/disconnecting the plug connector and receptacle connector, reducing the difficulty of connecting/disconnecting the plug connector and the receptacle connector.

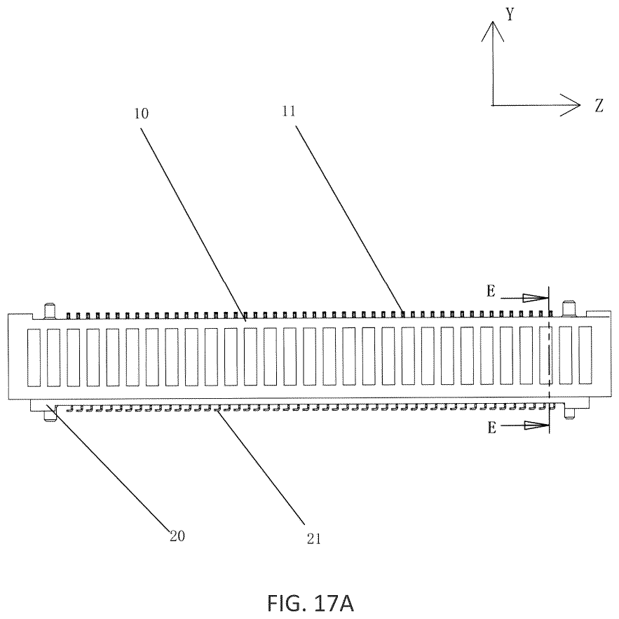

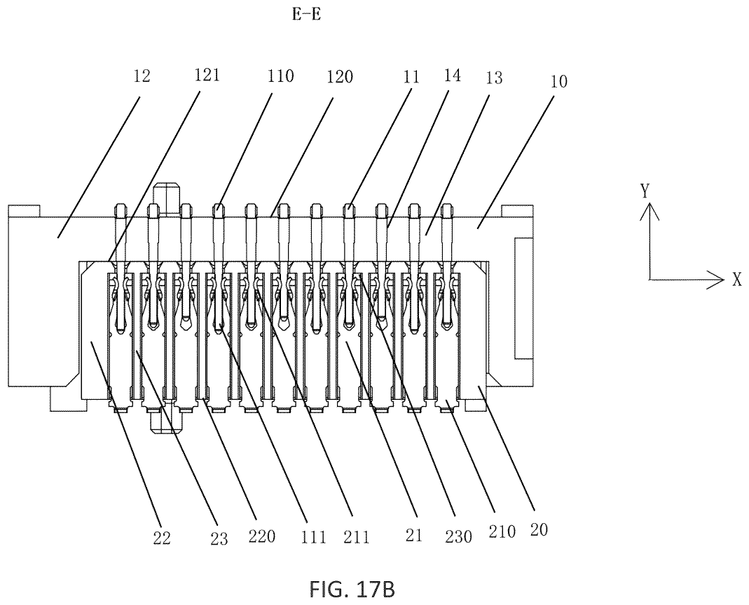

In some embodiments, as shown in FIG. 17B, when the plug connector 10 is engaged with the receptacle connector 20, a plug terminal mating end 111 of each plug terminal of the plug connector 10 is inserted in a first direction into a corresponding one of a plurality of receptacle housing channels 24 of the receptacle housing 22 of the receptacle connector 10 and is engaged with a receptacle terminal mating end 211 of the receptacle terminal 21 accommodated in the corresponding receptacle housing channel, so as to form an electrical connection. In some embodiments, the plug terminal mating end 111 is engaged with the first curved portion 2116 and the second curved portion 2117 of the receptacle terminal mating end 211 and is clamped between the first curved portion 2116 and the second curved portion 2117. The first curved portion 2116 and the second curved portion 2117 of the receptacle terminal mating end 211 simultaneously contacting and clamping the plug terminal mating end 111 provides reliability for the connection between the plug connector 10 and the receptacle connector 20, thereby reducing the risk of the plug terminal being accidentally pulled out.

In some embodiments, the plug housing 12 and the receptacle housing 22 may each comprise a positioning feature portion for forming a positive fit when the plug connector 10 is engaged with the receptacle connector 20. The plug housing 12 and the receptacle housing 22 are engaged by the corresponding positioning feature portions, thereby reducing the risk of the plug connector 10 and the receptacle connector 20 mating orientation overturning/misaligning during mating, and thereby providing guidance for the mating of the plug connector 10 and the receptacle connector 20.

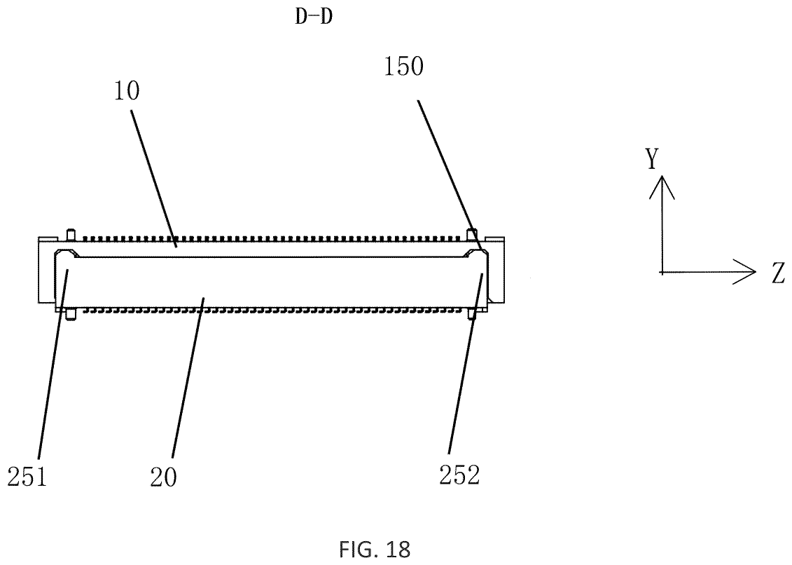

In some embodiments, referring to FIGS. 4 and 5, the plug housing sidewall 126 of the plug housing 12 may comprise a first end wall 138 and a second end wall 139 opposing each other in the third direction Z. The positioning feature portion for the plug housing 12 may comprise a plug housing base recessed portion 131 respectively formed at two ends opposite to each other in the third direction Z, of the mating side surface 121 of the plug housing base 13 of the plug connector 10, the first end wall 138, the second end wall 139 and the corresponding plug housing base recessed portion 131 form a groove 150 together (FIG. 18).

Referring to FIGS. 9 and 12, the positioning feature portion for the receptacle housing 22 may comprise a third end wall 251 and a fourth end wall 252 provided at opposite ends of the receptacle housing base 23 in the third direction Z. The third end wall 251 and the fourth end wall 252 may be configured to extend beyond the mating side surface 230 of the receptacle housing base 23 in the first direction Y such that: when the plug connector 10 is engaged with the receptacle connector 20, the third end wall 251 and the fourth end wall 252 are embedded in corresponding groove 150, respectively, as shown in FIG. 18. When the plug connector 10 is mated with the receptacle connector 20, the third end wall 251 and the fourth end wall 252 are first embedded in the groove 150. Thus, the third end wall 251 and the fourth end wall 252 provide guidance for the mating of the plug connector 10 with the receptacle connector 20.

In some embodiments, referring to FIGS. 4 and 5, the plug housing sidewall 126 may comprise a first sidewall 122 and a second sidewall 123 opposing each other in the second direction X, the positioning feature portion may also comprise a first sidewall recessed portion 1221 respectively provided at opposite ends of the first sidewall 122 in the third direction Z, and a first sidewall protrusion 124 provided between two first sidewall recessed portions 1221 adjacent to the corresponding one of the two first sidewall recessed portions respectively and protruding toward an interior of the plug housing 12. For example, the positioning feature portion for the plug housing 12 may also comprise the first sidewall recessed portion 1221 and the first sidewall protrusion 124. Alternatively, the first sidewall protrusion may also be provided to be spaced apart from the first sidewall recessed portion 1221.

In some embodiments, referring to FIGS. 9 and 12, a third end wall protrusion 2511 and a fourth end wall protrusion 2521 are respectively provided to extend beyond a side surface of the receptacle housing base 23 in the second direction X, on a side of the third end wall 251 and the fourth end wall 252 of the receptacle housing 22 corresponding to the first sidewall 122 of the plug housing 12 in the second direction X. For example, the positioning feature portion for the receptacle member 22 may also comprise the third end wall protrusion 2511 and the fourth end wall protrusion 2521.

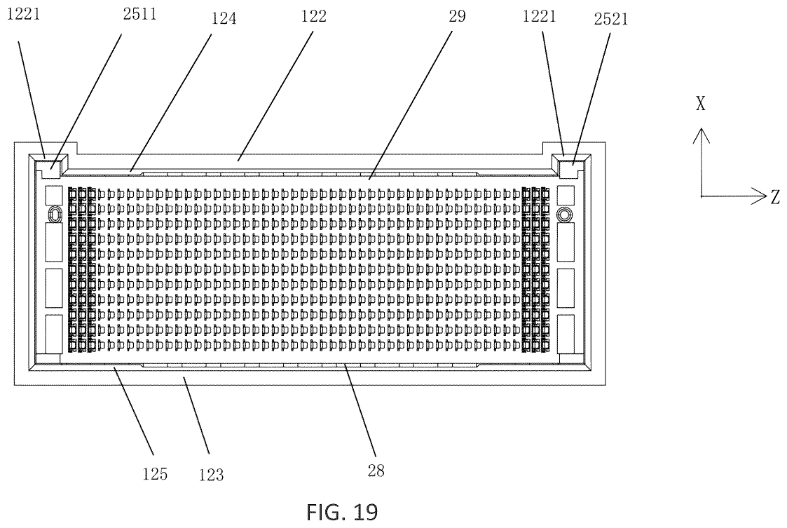

In some embodiments, referring to FIG. 19, when the plug connector 10 is engaged with the receptacle connector 20, the third end wall protrusion 2511 and the fourth end wall protrusion 2521 of the receptacle housing 22 of the receptacle connector 20 are engaged, respectively, in a positive fit manner into a corresponding first sidewall recessed portion 1221 provided in the first sidewall 122 of the plug connector 10. The first sidewall protrusion 124 abuts against a portion of a side surface of the receptacle housing 22 that is not provided with the third end wall protrusion 2511 and the fourth end wall protrusion 2521.

In some embodiments, referring to FIGS. 4, 5 and 19, the positioning feature portion may further comprise a second sidewall protrusion 125 respectively provided at opposite ends of the second sidewall 123 in the third direction Z and protruded toward an interior of the plug housing 12. When the plug connector 10 is engaged with the receptacle connector 20, the second sidewall protrusion 125 is engaged with a side surface of the receptacle housing 22 of the receptacle connector 20 that is not provided with the third sidewall protrusion 2511 and the fourth sidewall protrusion 2521. When the plug connector 10 is in an assembled state with the receptacle connector 20, the plug housing of the plug connector 10 contacts the receptacle housing 22 of the receptacle connector 20 by the second sidewall protrusion 125 and the first sidewall protrusion 124, so that the mating of the plug connector 10 and the receptacle connector 20 can be realized in the correct orientation.

In some embodiments, a distance between the third end wall 251 and the fourth end wall 252 of the receptacle housing 22 of the receptacle connector 20 is slightly larger than the distance between the first end wall 138 and the second end wall 139 of the plug connector 10 such that: when the plug connector 10 is mated with the receptacle connector 20, the corresponding plug terminal can be inserted into the corresponding receptacle terminal, thereby preventing a misaligned connection between the plug terminal and the receptacle terminal, and thereby reducing the risk of damaging the plug connector and the receptacle connector.

In some embodiments, each of the plug housing and the receptacle housing is made of a heat resistant electrically insulating material.

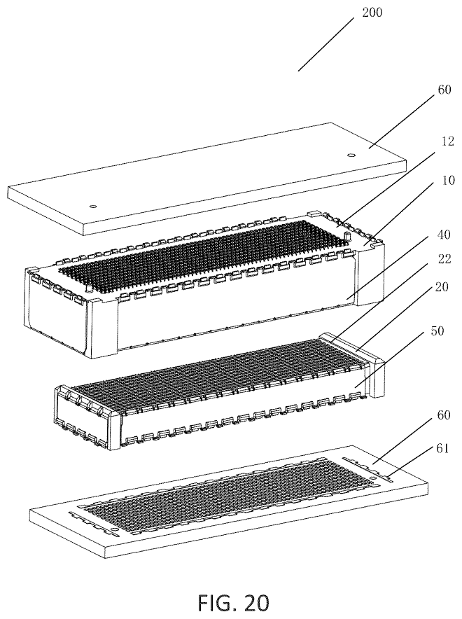

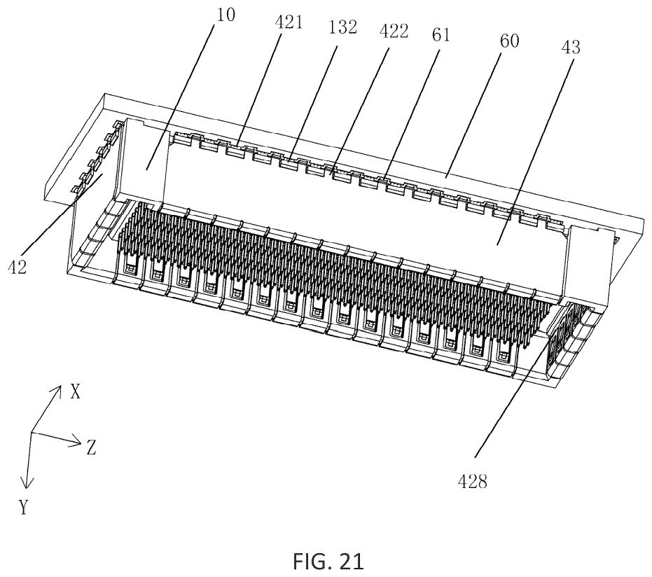

According to aspects of the present disclosure, an electronic system is provided. Referring to FIGS. 20 through 28C, in some embodiments, the electronic system 200 may comprise printed circuit boards 60 and an electronic system 100 according to the above aspects, the printed circuit boards 60 may be joined to the plug connector 10 and the receptacle connector 20 in the electronic system 100, respectively, and when the plug connector 10 is engaged with the receptacle connector 20, the printed circuit boards 60 are electrically connected to each other and form a substantially parallel configuration with each other.

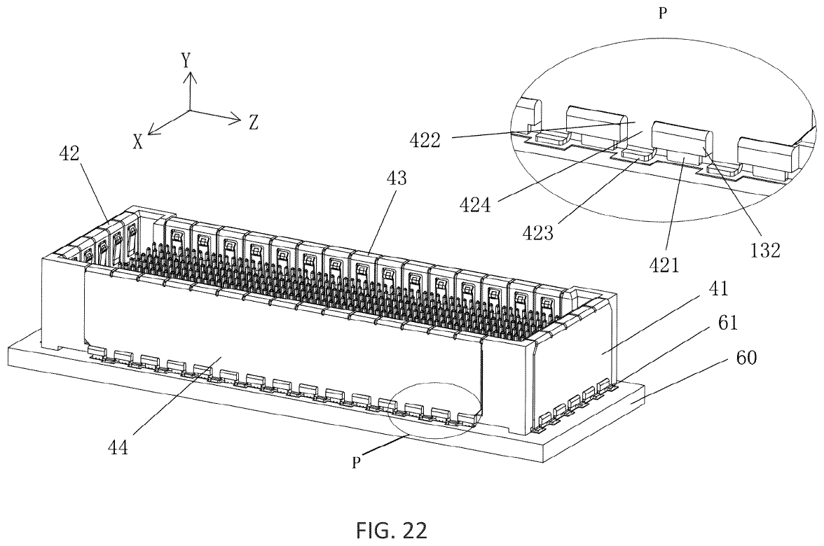

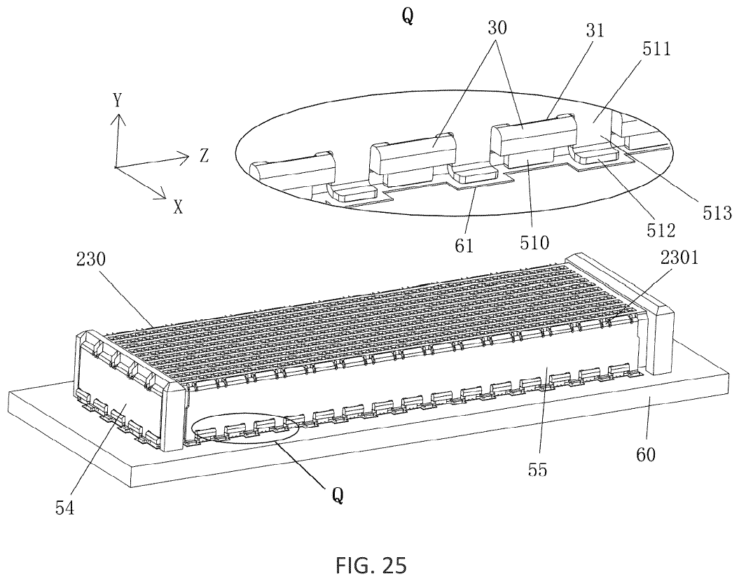

In some embodiments, a plug terminal tail 110 of each plug terminal 11 of the plug connector 10 may extend beyond a mounting side surface 120 of a plug housing base 13 of the plug housing 12 and be connected to a first printed circuit board 60. A receptacle terminal tail 212 of each receptacle terminal 21 of the receptacle connector 20 may extend beyond a mounting side surface 220 of the receptacle housing base 23 of the receptacle housing and be connected to a second printed circuit board 60, as shown in FIGS. 22 and 25.

In some embodiments, the plug terminal tail 110 of the plug terminal 11 that extends beyond the mounting side surface 120 of the plug housing base 13 may be shaped to have an L-shaped portion 1101 (FIG. 7), and the receptacle terminal tail 212 of the receptacle terminal 21 that extends beyond the mounting side surface 220 of the receptacle housing base 23 is shaped to have an L-shaped portion 2101 (FIG. 13). The L-shaped portion 1101 of the plug terminal 11 may be connected to a contact portion 61 of the first printed circuit board 60, and the L-shaped portion 2101 of the receptacle terminal 21 may be connected to a contact portion 61 of the second printed circuit board 60. In some embodiments, the L-shaped portion 1101 of the plug terminal 11 and/or the L-shaped portion 2101 of the receptacle terminal 21 may be formed by first thinning the proximal portions of the plug terminal 11 and/or the receptacle terminal 21 and then bending them. The L-shaped portion 1101 of the plug terminal 11 and/or the L-shaped portion 2101 of the receptacle terminal 21 may increase the contact area for contacting with the corresponding printed circuit board, thereby increasing the strength of the connection with the corresponding printed circuit board and ensuring the reliability of the electronic system. In addition, the L-shaped portion 1101 of the plug terminal 11 and/or the L-shaped portion 2101 of the receptacle terminal 21 may be directly soldered to a contact portion of the corresponding printed circuit board without the need to solder the plug terminal 11 and/or the receptacle terminal 21 to the corresponding printed circuit board using a separate soldering ball, thereby making it easier to manufacture the electronic system and lowering the manufacturing cost.

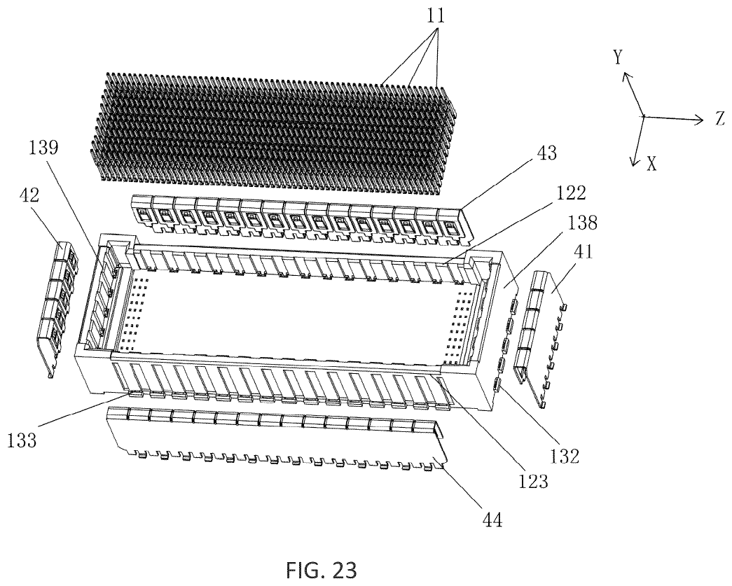

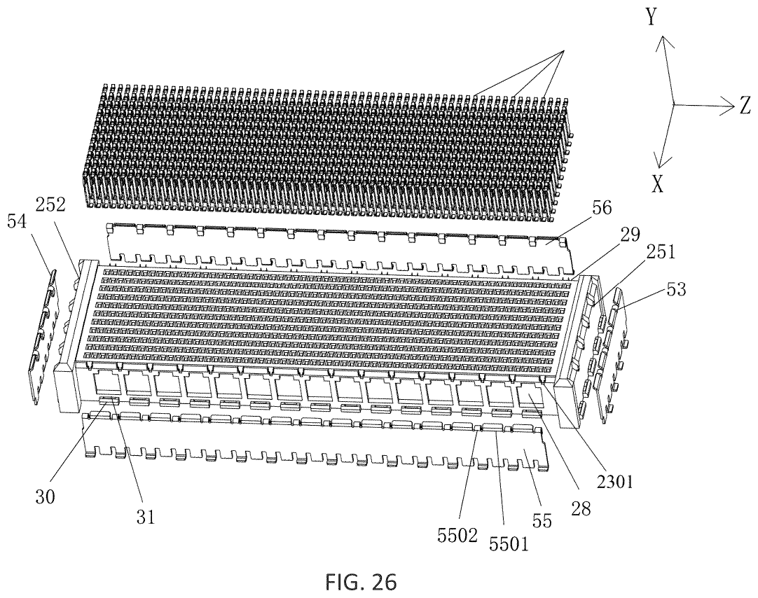

In some embodiments, referring to FIGS. 23 and 26, the plug connector 10 may comprise a first conductive member 40 disposed to a plug housing sidewall 126 of the plug housing 12, and the receptacle connector 20 may further comprise a second conductive member 50 disposed to an outer side of a receptacle housing base 23 of the receptacle housing 22. In some embodiments, the first conductive member 40 and the second conductive member 50 are made of metal. In some embodiments, the first conductive member 40 and the second conductive member 50 may be made of iron. The first conductive member and the second conductive member may be configured to carry a relatively large electrical current. The electronic system therefore may provide both signal and power transmissions, thereby saving space and reducing cost.

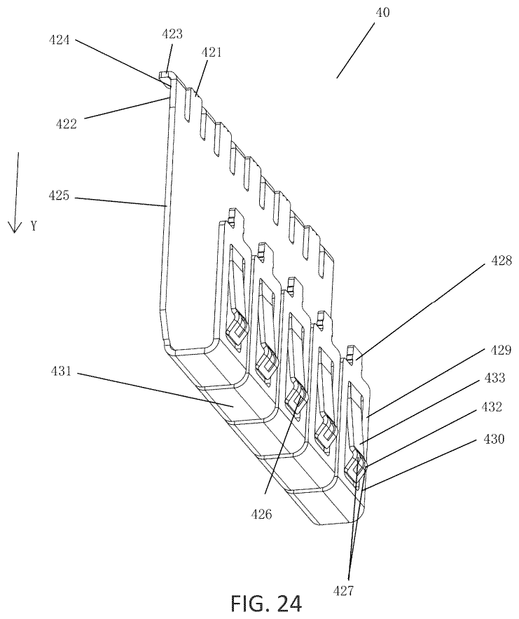

In some embodiments, referring to FIGS. 23 and 24, the first conductive member 40 may comprise: a first portion 41 disposed to a first end wall 138, a second portion 42 disposed to a second end wall 139, a third portion 43 disposed to a first sidewall 122, and a fourth portion 44 disposed to the second sidewall 123. The first portion 41, the second portion 42, the third portion 43, and the fourth portion 44 may be shaped as a U-shaped member having an outer portion 425 and an inner portion 430 and having an open end in the first direction Y toward a mounting side of the plug housing base 13. The first portion 41, the second portion 42, the third portion 43, and the fourth portion 44 may be disposed onto the first end wall 138, the second end wall 139, the first sidewall 122 and the second sidewall 123, respectively, in a removable manner via the open end, such that the outer portion 425 of the U-shaped member is engaged with outer surfaces of the first end wall 138, the second end wall 139, the first sidewall 122 and the second sidewall 123. The inner portion of the U-shaped member may be engaged with inner surfaces of the first end wall 138, the second end wall 139, the first sidewall 122 and the second sidewall 123 toward the interior of the plug housing, respectively. The first portion 41, the second portion 42, the third portion 43, and the fourth portion 44 may have corresponding lengths based on the lengths of the first end wall 138, the second end wall 139, the first sidewall 122, and the second sidewall 123 and have the same configuration. Thus, the first conductive member 40 may be manufactured in a modular manner and suitable first conductive members can be cut out based on the lengths of the first end wall 138, the second end wall 139, the first sidewall 122, and the second sidewall 123, which may save on manufacturing costs and ensures the consistency and stability of the first conductive member used to hold the plug connector.

In some embodiments, the U-shaped member of the first conductive member 40 comprising the first portion 41, the second portion 42, the third portion 43, and the fourth portion 44 may comprise a plurality of first flat straight extensions 421 and a plurality of first curved portions 422 alternately provided at an edge of the outer portion 425 of the U-shaped member close to a mounting side surface 120 of the plug housing base 13. The first curved portions 422 may comprise a first straight portion 424 provided in the same plane as the first flat straight extension 421 and a first bent portion 423 connected to the first straight portion 424. An end surface of the first flat straight extension 421 may be flush with an end surface of the first bent portion 423 of the first curved portion 422 in the first direction in a direction toward a mounting side of the plug housing base 13. An outer peripheral edge of a mating side surface 121 of the plug housing base 13 may comprise a plurality of first pockets 132 each with a first aperture 133. When the first conductive member 40 is disposed to the plug housing sidewall 126, the first curved portion 422 may be provided between adjacent first pockets 132 or the first pockets 132 may be provided between adjacent first curved portions 422. The first flat straight extension 421 of the first conductive member 40 may be inserted through the first aperture 133 in the first pockets 132 and extend beyond the mounting side surface 120 of the plug housing base 13 (sec enlarged view of the detail P in FIG. 22). The first flat straight extension 421 extending beyond the mounting side surface 120 of the plug housing base 13 may have the same dimensions as the dimensions of the plug terminal tail 110 of the plug terminal 11 extending beyond the mounting side surface 120 of the plug housing base 13, such that the contoured end surfaces of the plug terminal tail 110, the first flat straight extension 421, and the first bent portion 423 extending in the first direction Y in a direction toward the mounting side of the plug housing base 13 are flush, and that the plug terminal tail 110 and the first conductive member can be simultaneously connected to the contact portion 61 of the printed circuit board 60. In some embodiments, the plug terminal tail 110, the flat straight extension 421, and the first bent portion 423 of the first conductive member are simultaneously soldered to the contact portion 61 of the printed circuit board 60, thereby enhancing the reliability of the connection between the plug terminal 10 and the printed circuit board 60, as well as between the first conductive member 40 and the printed circuit board 60.

In some embodiments, as shown in FIG. 22, the first conductive member 40 is connected to a first printed circuit board 60 by end surfaces of the first flat straight extension 421 and the first bent portion 423 of the first curved portion 422 in the first direction Y in a direction toward the mounting side of the plug housing base 13, thereby ensuring a reliability of the connection between the plug connector 10 and the printed circuit board.

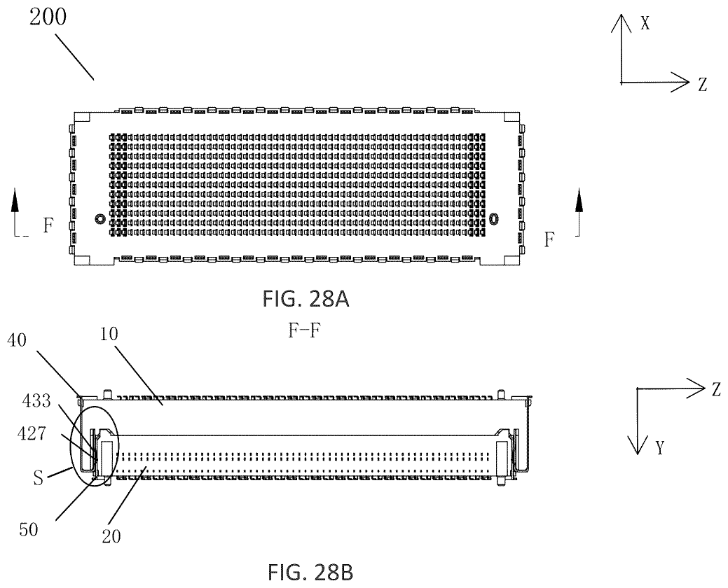

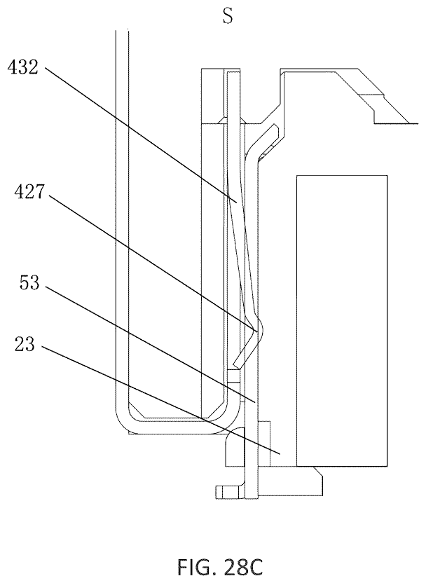

In some embodiments, as shown in FIGS. 23 and 24 and in conjunction with FIG. 28C, the inner portions of the U-shaped members of the first conductive member 40 comprising the first portion 41, the second portion 42, the third portion 43, and the fourth portion 44 may be configured as resiliently deformable members, such that, when the plug connector 10 is engaged with the receptacle connector 20, the inner portions of the U-shaped members of the first conductive member 40 comprising the first portion 41, the second portion 42, the third portion 43, and the fourth portion 44 each abuts against an outer surface of a receptacle housing base 23 of the receptacle connector 20 and exerts a biasing force on the receptacle connector 20 toward the interior of the plug housing 12 of the plug connector 10.

In some embodiments, as shown in FIG. 24, the inner portions of the U-shaped member of the first conductive member 40 comprising the first portion 41, the second portion 42, the third portion 43, and the fourth portion 44 may comprise a plurality of inner portions 430 spaced apart from each other and extending in the first direction Y in a direction toward a mounting side of the plug housing base 13. Each of the plurality of inner portions 430 may be connected to the outer portion 425 of the U-shaped member by a corresponding connecting portion 431. Each of the inner portions 430 may comprise a frame 429 and a cantilever 433. One end of the cantilever 433 may be connected to the frame 429 and the other end of the cantilever 433 may be separated from the frame 429 in the first direction Y to form a distal end 432, and the distal end 432 of the cantilever 433 is curved to protrude toward an interior of the plug housing 12 such that, when the plug connector 10 is engaged with the receptacle connector 20, the cantilever 433 of each of the inner portions 430 may abut against an outer surface of the receptacle connector 20 and exerts a biasing force on the receptacle connector 20 toward the interior of the plug housing 12 of the plug connector 10, as shown by FIG. 28.

In some embodiments, referring to FIG. 5, an inner side surface 127 of a plug housing sidewall 126 of the plug housing 12 of the plug connector 10 may comprise a plurality of sidewall grooves 128 and a plurality of sidewall projections 129. The plurality of sidewall grooves 128 and the plurality of sidewall projections 129 are arranged alternately. The plug housing base 13 of the plug housing 12 of the plug connector 10 may comprise a plurality of receiving portions 135 provided corresponding to the plurality of grooves 128. The receiving portions 135 may be recessed from a sidewall surface 121 of the plug housing base 13 in the first direction Y toward a mounting side of the plug housing base 13.

In some embodiments, as shown in FIG. 24, an end of each of the inner portions 430 opposite to the connecting portion 431 may comprise an extension 428. The extension 428 may be aligned with the cantilever 433 of the inner portions 430 in the first direction Y, so that, when the first conductive member 40 is disposed to the plug housing sidewall 126, the cantilever 433 of the inner portion 430 may be aligned with the sidewall groove 128 provided in the inner side surface 127 of the plug housing sidewall 126, and the extension 428 may be received in a receiving portion 135 corresponding to the groove 128, thereby increasing the stability of the connection between the first conductive member and the plug connector.

In FIG. 24, the cantilever 433 and the extension 428 may be provided respectively on opposite sides of a side portion of the frame 429. For example, the cantilever 433 may extend obliquely from the frame 429 in the first direction Y in a direction away from the mounting side of the plug housing base toward the interior of the plug housing of the plug connector. The extension 428 may extend from the frame 429 in the first direction Y in a direction toward the mounting side of the plug housing base. When the first conductive member 40 is disposed to the plug housing sidewall 126, the cantilever 433 of the inner portion 430 may be aligned with the sidewall groove 128 provided on the inner side surface 127 of the plug housing sidewall 126. In this way, the first conductive member 40 may be connected to the plug housing of the plug connector and the printed circuit board through the extension 428, the first flat straight extension 421, and the first curved portion 422, so that the first conductive member, the plug connector, and the printed circuit board are securely retained, and thus the stability of the electronic system is improved.

In some embodiments, as shown in FIG. 24, the distal end 432 of the cantilever 433 may comprise a recessed portion 426 such that paired contact portions 427 are formed at the distal end 432 of the cantilever 433. When the first conductive member 40 is disposed to the plug housing sidewall 126, the paired contact portions 427 may abut against an outer surface of the receptacle housing base 23 of the receptacle connector 20 and exert a biasing force on the receptacle connector 20 toward the interior of the plug housing 12 of the plug connector 10, as shown in FIG. 28C. When the plug connector 10 and the receptacle connector 20 are connected to each other, the paired contact portions 427 may abut against the second conductive member of the receptacle housing base 23, thereby realizing the ability to transmit larger currents while ensuring that the plug connector 10 contacts the receptacle connector 20.

In some embodiments, referring to FIGS. 25 to 27, the second conductive member 50 may comprise: a third end wall housing 53 and a fourth end wall housing 54 that are removably disposed to an outer side of a third end wall 251 and a fourth end wall 252, respectively, of the receptacle housing base 23 of the receptacle housing 22 in the third direction Z; and a third side portion housing 55 and a fourth side portion housing 56 that are removably disposed to an outer side of a third side portion 28 and a fourth side portion 29, respectively, of the receptacle housing base 23 of the receptacle housing 22 in the second direction X. Each of the third end wall housing 53, the fourth end wall housing 54, the third side portion housing 55, and the fourth side portion housing 56 may comprise a housing engaging portion 550 configured for engagement with an edge of a mating side surface 230 of the receptacle housing base 23, and a housing attachment portion 51 configured to be adjacent to the mounting side surface 220 of the receptacle housing base 23.

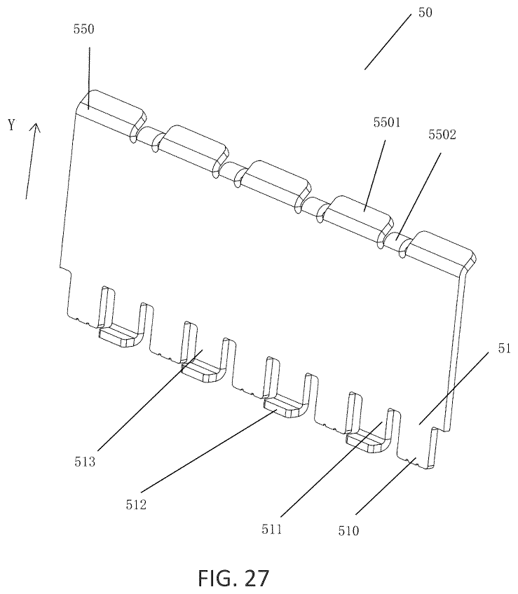

In some embodiments, referring to FIGS. 25 and 26, the edge of the mating side surface 230 of the receptacle housing base 23 may comprise recessed portions 2301 provided spaced apart. Referring to FIG. 27, the housing engaging portion 550 may comprise a plurality of first tabs 5501 and a plurality of second tabs 5502 provided alternately. The second tab 5502 may be configured to curve toward the receptacle housing base 23 and engage with the recessed portion 2301. Optionally, the first tabs 5501 are curved toward the receptacle housing base 23 and abut against the edge of the mating side surface 230 of the receptacle housing base 23. In some embodiments, the edge of the mounting side surface 220 of the receptacle housing base 23 comprises a plurality of second pockets 30 provided spaced apart, each of the second pockets 30 may comprise a second aperture 31.

Referring to FIG. 27, the housing attachment portion 51 may comprise a plurality of second flat straight extensions 510 and a plurality of second curved portions 511 provided alternately. The second curved portions 511 may comprise a second straight portion 513 provided in the same plane as the second flat straight extension 510 and a second bent portion 512 connected to the second straight portion 513. An end surface of the second flat straight extension 510 may be flush with an end surface of the second bent portion 512 of the second curved portion 511 in the first direction Y in a direction toward a mounting side of the receptacle housing base 23.

Referring to FIG. 25, when the second conductive member 50 is disposed to an outer side of the receptacle housing base 23, the second curved portion 511 may be provided between adjacent two second pockets 30, or the second pockets 30 may be provided between adjacent two second curved portions 511 (referring to the enlarged view of the detail Q in FIG. 25). The second flat straight extension 510 of the second conductive member 50 may be inserted through the second aperture 31 in the second pocket 30 and extends beyond the mounting side surface 220 of the receptacle housing base 23. The second flat straight extension 510 extending beyond the mounting side surface 220 of the receptacle housing base 23 may have the same dimensions as the dimensions of the receptacle terminal tail 212 of the receptacle terminal 11 extending beyond the mounting side surface 220 of the receptacle housing base 23, such that contour end surfaces of the receptacle terminal tail 212. The flat straight extension 510 and the second bent portion 512 may be flushed from each other in the first direction Y in a direction extending toward the mounting side of the receptacle housing base, such that the receptacle terminal tail 212 and the second conductive member can be connected to the contact portion 61 of the printed circuit board 60 at the same time. In some embodiments, the receptacle terminal tail 212, the flat extension 510 and the second bent portion 512 of the second conductive member may be simultaneously soldered to the contact portion 61 of the printed circuit board 60, thereby enhancing the reliability of the connection between the receptacle terminal 10 and the printed circuit board 60 as well as between the second conductive member 50 and the printed circuit board 60.

In some embodiments, as shown in FIG. 25, the second conductive member 50 may be connected to a second printed circuit board 60 by the end surfaces of the second flat straight extension 510 and the second bent portion 512 of the second curved portion 511 in the first direction Y in a direction toward the mounting side of the receptacle housing base, thereby ensuring the stability of the connection between the receptacle connector 20 and the printed circuit board.

In some embodiments, the extending length of a corresponding one of the first portion 41, the second portion 42, the third portion 43, and the fourth portion 44 of the first conductive member 40 for the plug connector 10 may be determined based on the extending length of the plug housing sidewall of the plug connector. The extending length of a corresponding one of the third end wall housing 53, the fourth end wall housing 54, the third side portion housing 55 and the fourth side portion housing 56 of the second conductive member 50 for the receptacle connector 20 may be determined based on the extending length of the corresponding one of the third end wall 251, the fourth end wall 252, the third side portion 28, and the fourth side portion 29 of the receptacle housing base of the receptacle connector. Accordingly, the first conductive member 40 and the second conductive member 50 may be cut to have corresponding lengths according to the connector configuration, thereby ensuring consistency of the housings for being disposed to the plug connector and the receptacle connector and ensuring stability of current transmission.

Various aspects are described in this disclosure, which include, but are not limited to, the following aspects:
1. A plug connector (e.g., 10) comprising a plurality of plug terminals (e.g., 11) arranged into an array of plug terminals, and a plug housing (e.g., 12) for holding the plug terminals (e.g., 11), wherein adjacent rows of plug terminals arranged in the second direction (e.g., X) or adjacent columns of plug terminals arranged in the third direction (e.g., Z) have different heights in the first direction (e.g., Y).
2. The plug connector of aspect 1, wherein the array of plug terminals comprises at least three rows and/or at least three columns of plug terminals, the plug terminals (e.g., 11) arranged in the same row or in the same column have the same height in the first direction (e.g., Y), and the plug terminals in the array of plug terminals are arranged so as to have the same dimensions and configurations in every two rows or in every two columns.
3. The plug connector of aspects 1 or 2, wherein the plug terminal (e.g., 11) comprises a plug terminal tail (e.g., 110), a plug terminal mating end (e.g., 111), and an intermediate portion (e.g., 112) connecting the plug terminal tail (e.g., 110) with the plug terminal mating end (e.g., 111), and the plug terminal mating end (e.g., 111) has an outer contour dimension (e.g., W1) in the second direction (e.g., X) less than an outer contour dimension (e.g., W2) of the plug terminal tail (e.g., 110) in the second direction (e.g., X).
4. The plug connector of aspect 3, wherein the plug terminal mating end (e.g., 111) has an outer contour dimension in the third direction (e.g., Z) less than an outer contour dimension of the plug terminal tail (e.g., 110) in the third direction (e.g., Z).
5. The plug connector of aspect 4, wherein the plug housing (e.g., 12) of the plug connector (e.g., 10) comprises a plug housing base (e.g., 13) which comprises a plurality of plug housing channels (e.g., 14) arranged in an array as the same as the array of plug terminals, and each plug terminal of the plug connector (e.g., 10) extends through a corresponding one of the plurality of plug housing channels (e.g., 14), such that the plug terminal mating end (e.g., 111) of each of the plug terminals (e.g., 11) extends beyond a mating side surface (e.g., 121) of the plug housing base (e.g., 13), and the plug terminal tail (e.g., 110) of each of the plug terminals extends beyond a mounting side surface (e.g., 120) of the plug housing base (e.g., 13).
6. The plug connector of aspect 5, wherein the plug housing channel (e.g., 14) comprises a plug housing channel first portion (e.g., 140) for holding the plug terminal mating end (e.g., 111) in a positive fit manner and a plug housing channel second portion (e.g., 141) for holding the plug terminal tail (e.g., 110) in a positive fit manner, the plug housing channel first portion (e.g., 140) has a dimension (e.g., D1) in the second direction (e.g., X) less than a dimension (e.g., D2) of the plug housing channel second portion (e.g., 141) in the second direction (e.g., X).
7. The plug connector of aspect 6, wherein the plug housing channel first portion (e.g., 140) has a dimension in the third direction (e.g., Z) less than a dimension of the plug housing channel second portion (e.g., 141) in the third direction (e.g., Z).
8. The plug connector of aspects 6 or 7, wherein the plug terminal tail (e.g., 110) comprises at least one projection (e.g., 1120) which extends in the second direction (e.g., X) and protrudes from opposite sides of the plug terminal tail (e.g., 110) and which is provided adjacent to a proximal end of the plug terminal tail (e.g., 110), the projection (e.g., 1120) is configured to be tapered from a side of the plug terminal tail toward a side of the plug terminal mating end in the first direction (e.g., Y), when the plug terminal tail (e.g., 110) is accommodated in the plug housing channel second portion (e.g., 141), at least a portion of the projection (e.g., 1120) abuts with opposing two inner side surfaces of the plug housing channel second portion (e.g., 141) in the second direction (e.g., X).
9. The plug connector of aspects 6 or 7, wherein the intermediate portion (e.g., 112) comprises a curved portion, the curved portion is configured such that a center axis (e.g., L1) of the plug terminal tail (e.g., 110) extending in the first direction (e.g., Y) and a center axis (e.g., L2) of the plug terminal mating end (e.g., 111) extending in the first direction (e.g., Y) are offset from each other by a certain distance (e.g., L) in the third direction (e.g., Z), when the plug terminal tail (e.g., 110) is accommodated in the plug housing channel second portion (e.g., 141), an outer side surface of the plug terminal tail (e.g., 110) in the third direction (e.g., Z) away from the center axis (e.g., L1) of the plug terminal tail (e.g., 110) abuts against an inner side surface of the plug housing channel second portion (e.g., 141) in the third direction (e.g., Z).
10. The plug connector of aspects 5 or 6, wherein the plug housing (e.g., 12) of the plug connector (e.g., 10) comprises a plug housing sidewall (e.g., 126) extending from an outer peripheral edge of the plug housing base (e.g., 13) in the first direction (e.g., Y), the plug housing sidewall (e.g., 126) is integrally formed with the plug housing base (e.g., 13), and the plug housing sidewall (e.g., 126) has a dimension extending in the first direction (e.g., Y) greater than a dimension of a portion of the plug terminal (e.g., 11) that extends beyond a mating side surface (e.g., 121) of the plug housing base (e.g., 13).
11. A receptacle connector (e.g., 20) comprising a plurality of receptacle terminals (e.g., 21) arranged into an array of receptacle terminals, and a receptacle housing (e.g., 22) for holding the receptacle terminal (e.g., 21), the receptacle terminals (e.g., 21) in the array of receptacle terminals are arranged in rows in the second direction (e.g., X) and in columns in the third direction (e.g., Z).
12. The receptacle connector of aspect 11, wherein each of the plurality of the receptacle terminals (e.g., 21) has the same dimension in the first direction (e.g., Y).
13. The receptacle connector of aspects 11 or 12, wherein the receptacle terminal (e.g., 21) comprises a receptacle terminal mating end (e.g., 211) and a receptacle terminal intermediate portion (e.g., 210), the receptacle terminal intermediate portion (e.g., 210) is shaped as a plate-like portion, the receptacle terminal mating end (e.g., 211) comprises beams extending from the receptacle terminal intermediate portion (e.g., 210) of the receptacle terminal (e.g., 210), the beams comprises a first beam (e.g., 2110) and a second beam (e.g., 2111), the first beam (e.g., 2110) and the second beam (e.g., 2111) are formed such that they are spaced apart at a portion adjacent to the receptacle terminal intermediate portion (e.g., 210) and are close to each other at a distal end away from the receptacle terminal intermediate portion (e.g., 210) so as to form a clamping portion.
14. The receptacle connector of aspect 13, wherein the first beam (e.g., 2110) comprises a first beam proximal portion (e.g., 2113) adjacent to the receptacle terminal intermediate portion (e.g., 210) and a first beam distal portion (e.g., 2112) away from the receptacle terminal intermediate portion (e.g., 210), the second beam (e.g., 2111) comprises a second beam proximal portion (e.g., 2115) adjacent to the receptacle terminal intermediate portion (e.g., 210) and a second beam distal portion (e.g., 2114) away from the receptacle terminal intermediate portion (e.g., 210), a distance between the first beam distal portion (e.g., 2112) and the second beam distal portion (e.g., 2114) being less than a distance between the first beam proximal portion (e.g., 2113) and the second beam proximal portion (e.g., 2115).
15. The receptacle connector of aspect 14, wherein the first beam distal portion (e.g., 2112) comprises a first flat portion (e.g., 2118) continuous with the first beam proximal portion (e.g., 2113) and a first curved portion (e.g., 2116) helically extending from the first flat portion (e.g., 2118) in a first helical direction to gradually away from the first flat portion (e.g., 2118), the second beam distal portion (e.g., 2114) comprises a second flat portion (e.g., 2119) continuous with the second beam proximal portion (e.g., 2115) and a second curved portion (e.g., 2117) helically extending from the second flat portion (e.g., 2119) in a second helical direction opposite to the first helical direction to gradually away from the second flat portion (e.g., 2119), the first curved portion (e.g., 2116) and the second curved portion (e.g., 2117) are configured to be spaced apart from each other and oriented toward each other, and a distance between the first curved portion (e.g., 2116) and the second curved portion (e.g., 2117) spaced apart from each other is less than a distance between the first beam proximal portion (e.g., 2113) and the second beam proximal portion (e.g., 2115), thereby forming the clamping portion.
16. The receptacle connector of aspect 13, wherein the receptacle housing (e.g., 22) of the receptacle connector (e.g., 20) comprises a receptacle housing base (e.g., 23), the receptacle housing base (e.g., 23) comprises a plurality of receptacle housing channels (e.g., 24) arranged in an array as the same as the array of receptacle terminals, and each receptacle terminal of the receptacle connector (e.g., 20) is accommodated in a corresponding one of the plurality of receptacle housing channels (e.g., 24), such that the receptacle terminal mating end (e.g., 211) of each of the receptacle terminals (e.g., 21) is not visible from a mating side surface (e.g., 230) of the receptacle housing base (23), and the receptacle terminal tail (e.g., 212) of each of the receptacle terminals (e.g., 21) extends beyond a mounting side surface (e.g., 220) of the receptacle housing base (e.g., 23).
17. An electronic system (e.g., 100) comprising a plug connector of any one of aspects 1 to 10 and a receptacle connector of any one of aspects 11 to 16 provided in pairs, wherein, when the plug connector (e.g., 10) and the receptacle connector (e.g., 20) are engaged with each other, the mating side surface (e.g., 121) of the plug housing base (e.g., 13) of the plug connector and the mating side surface (e.g., 230) of the receptacle housing base (e.g., 23) of the receptacle connector (e.g., 20) are oriented towards each other in the first direction (e.g., Y) such that a plurality of the plug terminals (e.g., 11) arranged into the array of the plug terminals are engaged with the plurality of the receptacle terminals (e.g., 21) arranged into the array of the receptacle terminals in a one-to-one correspondence, so as to form an electrical connection.
18. The electronic system of aspect 17, wherein when the plug connector (e.g., 10) is engaged with the receptacle connector (e.g., 20), a plug terminal mating end (e.g., 111) of each plug terminal of the plug connector (e.g., 10) is inserted in a first direction (e.g., Y) into a corresponding one of a plurality of receptacle housing channels (e.g., 24) of the receptacle housing (e.g., 22) of the receptacle connector (e.g., 20) and is engaged with a receptacle terminal mating end (e.g., 211) of the receptacle terminal (e.g., 21) accommodated in the corresponding receptacle housing channel, so as to form an electrical connection.
19. The electronic system of aspect 18, wherein the plug terminal mating end (e.g., 111) of the plug terminal (e.g., 11) is engaged with the first curved portion (e.g., 2116) and the second curved portion (e.g., 2117) of the receptacle terminal mating end (e.g., 211) of the receptacle terminal (e.g., 21) and is clamped between the first curved portion (e.g., 2116) and the second curved portion (e.g., 2117).
20. The electronic system of any one of aspects 17 to 19, wherein the plug housing (e.g., 12) and the receptacle housing (e.g., 22) each comprises a positioning feature portion for forming a positive fit when the plug connector (e.g., 10) is engaged with the receptacle connector (e.g., 20).
21. The electronic system of aspect 20, wherein the plug housing sidewall (e.g., 126) of the plug housing (e.g., 12) comprises a first end wall (e.g., 138) and a second end wall (e.g., 139) opposing each other in the third direction (e.g., Z), and the positioning feature portion comprises: a plug housing base recessed portion (e.g., 131) respectively formed at opposite ends of the mating side surface (e.g., 121) in the third direction (e.g., Z) of the plug housing base (e.g., 13) of the plug connector (e.g., 10), and a third end wall (e.g., 251) and a fourth end wall (e.g., 252) provided at opposite ends of the receptacle housing base (e.g., 23) of the receptacle connector (e.g., 20) in the third direction (e.g., Z), wherein the third end wall (e.g., 251) and the fourth end wall (e.g., 252) are configured to extend beyond the mating side surface (e.g., 230) of the receptacle housing base (e.g., 23) in the first direction (e.g., Y) such that: when the plug connector (e.g., 10) is engaged with the receptacle connector (e.g., 20), the third end wall (e.g., 251) and the fourth end wall (e.g., 252) are respectively embedded into a groove (e.g., 150) formed by the first end wall (e.g., 138) and the second end wall (e.g., 139) together with a corresponding plug housing base recessed portion (e.g., 131).
22. The electronic system of aspect 21, wherein the plug housing sidewall (e.g., 126) comprises a first sidewall (e.g., 122) and a second sidewall (e.g., 123) opposite to each other in the second direction (e.g., X), and the positioning feature portion further comprises: first sidewall recessed portions (e.g., 1221) respectively provided at opposite ends of the first sidewall (e.g., 122) in the third direction (e.g., Z), and first sidewall protrusions (e.g., 124) provided between two first sidewall recessed portions in a manner that being adjacent to the corresponding one of the two first sidewall recessed portions respectively and protruding toward an interior of the plug housing (e.g., 12); and a third end wall protrusion (e.g., 2511) and a fourth end wall protrusion (e.g., 2521) respectively provided to extend beyond a side surface of the receptacle housing base (e.g., 23) in the second direction (e.g., X), on a side of the third end wall (e.g., 251) and the fourth end wall (e.g., 252) of the receptacle housing (e.g., 22) corresponding to the first sidewall (e.g., 122) of the plug housing (e.g., 12) in the second direction (e.g., X), wherein when the plug connector (e.g., 10) is engaged with the receptacle connector (e.g., 20), the third end wall protrusion (e.g., 2511) and the fourth end wall protrusion (e.g., 2521) of the receptacle connector (e.g., 20) are engaged, respectively, in a positive fit manner into a corresponding first sidewall recessed portion (e.g., 1221) provided in the first sidewall (e.g., 122) of the plug connector (e.g., 10), and the first sidewall protrusion (e.g., 124) abuts against a portion of a side surface of the receptacle housing (e.g., 22) that is not provided with the third end wall protrusion (e.g., 2511) and the fourth end wall protrusion (e.g., 2521).
23. The electronic system of aspect 22, wherein the positioning feature portion further comprises: a second sidewall protrusion (e.g., 125) respectively provided at opposite ends of the second sidewall (e.g., 123) in the third direction (e.g., Z) and protruded toward an interior of the plug housing (e.g., 12), wherein, when the plug connector (e.g., 10) is engaged with the receptacle connector (e.g., 20), the second sidewall protrusion (e.g., 125) is engaged with a side surface of the receptacle housing (e.g., 22) of the receptacle connector (e.g., 20) that is not provided with the third end wall protrusion (e.g., 2511) and the fourth end wall protrusion (e.g., 2521).
24. An electronic system (e.g., 200) comprising: printed circuit boards (e.g., 60), and the electronic system of one of aspects 17 to 23; wherein the printed circuit boards (e.g., 60) are joined to the plug connector (e.g., 10) and the receptacle connector (e.g., 20) in the electronic system, respectively, and when the plug connector (e.g., 10) is engaged with the receptacle connector (e.g., 20), the printed circuit boards (e.g., 60) are electrically connected to each other and form a substantially parallel configuration with each other.
25. The electronic system of aspect 24, wherein the plug terminal tail (e.g., 110) of each plug terminal (e.g., 11) of the plug connector (e.g., 10) extends beyond a mounting side surface (e.g., 120) of a plug housing base (e.g., 13) of the plug housing (e.g., 12) and is connected to a first printed circuit board (e.g., 60), and a receptacle terminal tail of each receptacle terminal (e.g., 21) of the receptacle connector (e.g., 20) extends beyond a mounting side surface (e.g., 220) of the receptacle housing base (e.g., 23) of the receptacle housing and is connected to a second printed circuit board (e.g., 60).
26. The electronic system of aspect 25, wherein the plug terminal tail (e.g., 110) of the plug terminal (e.g., 11) that extends beyond the mounting side surface (e.g., 120) of the plug housing base (e.g., 13) is shaped to have an L-shaped portion (e.g., 1101), and the receptacle terminal tail (e.g., 212) of the receptacle terminal (e.g., 21) that extends beyond the mounting side surface (e.g., 220) of the receptacle housing base (e.g., 23) is shaped to have an L-shaped portion (e.g., 2101).
27. An electronic system of any one of aspects 24 to 26, wherein the plug connector (e.g., 10) further comprises a first conductive member (e.g., 40) disposed to a plug housing sidewall (e.g., 126) of the plug housing (e.g., 12), and the receptacle connector (e.g., 10) comprises a second conductive member (e.g., 50) disposed to an outer side of a receptacle housing base (e.g., 23) of the receptacle housing (e.g., 22).
28. The electronic system of aspect 27, wherein the first conductive member (e.g., 40) comprises: a first portion (e.g., 41) disposed to a first end wall (e.g., 138) of the plug housing, a second portion (e.g., 42) disposed to a second end wall (e.g., 139) of the plug housing, a third portion (e.g., 43) disposed to a first sidewall (e.g., 122) of the plug housing, and a fourth portion (e.g., 44) disposed to the second sidewall (e.g., 123) of the plug housing, the first portion (e.g., 41), the second portion (e.g., 42), the third portion (e.g., 43), and the fourth portion (e.g., 44) are shaped as a U-shaped member having an outer portion (e.g., 425) and an inner portion (e.g., 430) and having an open end in the first direction (e.g., Y) toward a mounting side of the plug housing base (e.g., 13) of the plug housing, wherein the first portion (e.g., 41), the second portion (e.g., 42), the third portion (e.g., 43), and the fourth portion (e.g., 44) are disposed onto the first end wall (e.g., 138), the second end wall (e.g., 139), the first sidewall (e.g., 122) and the second sidewall (e.g., 123), respectively, in a removable manner via the open end, such that the outer portion (e.g., 425) of the U-shaped member is engaged with outer surfaces of the first end wall (e.g., 138), the second end wall (e.g., 139), the first sidewall (e.g., 122) and the second sidewall (e.g., 123), and the inner portion of the U-shaped member is engaged with inner surfaces of the first end wall (e.g., 138), the second end wall (e.g., 139), the first sidewall (e.g., 122) and the second sidewall (e.g., 123) toward the interior of the plug housing.
29. The electronic system of aspect 28, wherein the U-shaped member of the first conductive member (e.g., 40) comprises a plurality of first flat straight extensions (e.g., 421) and a plurality of first curved portions (e.g., 422) alternately provided at an edge of the outer portion (e.g., 425) of the U-shaped member close to a mounting side surface (e.g., 120) of the plug housing base (e.g., 13), wherein each of the first curved portions (e.g., 422) comprises a first straight portion (e.g., 424) provided in the same plane as the first flat straight extension (e.g., 421) and a first bent portion (e.g., 423) connected to the first straight portion (e.g., 424), an end surface of the first flat straight extension (e.g., 421) is flush with an end surface of the first bent portion (e.g., 423) of the first curved portion (e.g., 422) in the first direction (e.g., Y) in a direction toward a mounting side of the plug housing base (e.g., 13), and an outer peripheral edge of a mating side surface (e.g., 121) of the plug housing base (e.g., 13) comprises a plurality of first pockets (e.g., 132) each with a first aperture (e.g., 133), wherein when the first conductive member (e.g., 40) is disposed onto the plug housing sidewall (e.g., 126), the first curved portion (e.g., 422) is arranged between adjacent first pockets (e.g., 132) or the first pockets (e.g., 132) are arranged between adjacent first curved portions (e.g., 422), the first flat straight extension (e.g., 421) of the first conductive member (e.g., 40) is inserted through the first aperture (e.g., 133) in the first pockets (e.g., 132) and extend beyond the mounting side surface (e.g., 120) of the plug housing base (e.g., 13), and the first flat straight extension (e.g., 421) extending beyond the mounting side surface (e.g., 120) of the plug housing base (e.g., 13) has the same dimensions as the dimensions of the plug terminal tail (e.g., 110) of the plug terminal (e.g., 11) extending beyond the mounting side surface (e.g., 120) of the plug housing base (e.g., 13).
30. The electronic system of aspect 29, wherein the first conductive member (e.g., 40) is connected to a first printed circuit board (e.g., 60) by end surfaces of the first flat straight extension (e.g., 421) and the first bent portion (e.g., 423) of the first curved portion (e.g., 422) in the first direction (e.g., Y) in a direction toward the mounting side of the plug housing base (e.g., 13).
31. The electronic system of aspect 28, wherein the inner portions of the U-shaped members of the first conductive member (e.g., 40) are configured as resiliently deformable members, such that, when the plug connector (e.g., 10) is engaged with the receptacle connector (e.g., 20), the inner portions of the U-shaped members of the first conductive member (e.g., 40) each abuts against an outer surface of a receptacle housing base (e.g., 23) of the receptacle connector (e.g., 20) and exerts a biasing force on the receptacle connector (e.g., 20) toward the interior of the plug housing (e.g., 12) of the plug connector (e.g., 10).
32. The electronic system of aspect 31, wherein the inner portions of the U-shaped member of the first conductive member (e.g., 40) comprise a plurality of inner portion (e.g., 430) spaced apart from each other and extending in a first direction (e.g., Y) in a direction toward a mounting side of the plug housing base (e.g., 13), each of the plurality of inner portions (e.g., 430) is connected to the outer portion (e.g., 425) of the U-shaped member by a corresponding connecting portion (e.g., 431), each of the inner portion (e.g., 430) comprises a frame (e.g., 429) and a cantilever (e.g., 433), one end of the cantilever (e.g., 433) is connected to the frame (e.g., 429) and the other end of the cantilever (e.g., 433) is separated from the frame (e.g., 429) in the first direction (e.g., Y) to form a distal end (e.g., 432), and the distal end (e.g., 432) of the cantilever (e.g., 433) is curved to protrude toward an interior of the plug housing (e.g., 12) such that, when the plug connector (e.g., 10) is engaged with the receptacle connector (e.g., 20), the cantilever (e.g., 433) of each of the inner portion (e.g., 430) abuts against an outer surface of the receptacle housing base (e.g., 23) of the receptacle connector (e.g., 20) and exerts a biasing force on the receptacle connector (e.g., 20) toward the interior of the plug housing (e.g., 12) of the plug connector (e.g., 10).
33. The electronic system of aspect 32, wherein an inner side surface (e.g., 127) of a plug housing sidewall (e.g., 126) of the plug housing (e.g., 12) of the plug connector (e.g., 10) comprises a plurality of sidewall grooves (e.g., 128) and a plurality of sidewall projections (e.g., 129) arranged alternately, the plug housing base (e.g., 13) of the plug housing (e.g., 12) of the plug connector (e.g., 10) comprises a plurality of receiving portions (e.g., 135) corresponding to the plurality of sidewall grooves (e.g., 128), and the receiving portions (e.g., 135) is recessed from a sidewall surface (e.g., 121) of the plug housing base (e.g., 13) in the first direction (e.g., Y) toward a mounting side of the plug housing base (e.g., 13).
34. The electronic system of aspect 33, wherein an extension (e.g., 428) is provided at an end of each of the inner portions (e.g., 430) opposite to the connecting portion (e.g., 431), and the extension (e.g., 428) is aligned with the cantilever (e.g., 433) of the inner portion (e.g., 430) in the first direction (e.g., Y), so that, when the first conductive member (e.g., 40) is disposed onto the plug housing sidewall (e.g., 126), the cantilever (e.g., 433) of the inner portion (e.g., 430) is aligned with the sidewall groove (e.g., 128) provided in the inner side surface (e.g., 127) of the plug housing sidewall (e.g., 126), and the extension (e.g., 428) is received in the receiving portion (e.g., 135) corresponding to the sidewall groove (e.g., 128).
35. The electronic system of aspect 34, wherein the distal end (e.g., 432) of the cantilever (e.g., 433) comprises a recessed portion (e.g., 426) such that paired contact portions (e.g., 427) are formed at the distal end (e.g., 432) of the cantilever (e.g., 433).
36. The electronic system of aspect 27, wherein the second conductive member (e.g., 50) comprises: a third end wall housing (e.g., 53) and a fourth end wall housing (e.g., 54) that are removably disposed to outer sides of a third end wall (e.g., 251) and a fourth end wall (e.g., 252), respectively, of the receptacle housing base (e.g., 23) of the receptacle housing (e.g., 22) in the third direction (e.g., Z); and a third side portion housing (e.g., 55) and a fourth side portion housing (e.g., 56) that are removably disposed to outer sides of a third side portion (e.g., 28) and a fourth side portion (e.g., 29), respectively, of the receptacle housing base (e.g., 23) of the receptacle housing (e.g., 22) in the second direction (e.g., X), and each of the third end wall housing (e.g., 53), the fourth end wall housing (e.g., 54), the third side portion housing (e.g., 55) and the fourth side portion housing (e.g., 56) comprises a housing engaging portion (e.g., 550) configured for engagement with an edge of a mating side surface (e.g., 230) of the receptacle housing base (e.g., 23), and a housing attachment portion (e.g., 51) configured to be adjacent to the mounting side surface (e.g., 220) of the receptacle housing base (e.g., 23).
37. The electronic system of aspect 36, wherein an edge of a mating side surface (e.g., 230) of the receptacle housing base (e.g., 23) comprises recessed portions (e.g., 2301) provided spaced part, the housing engaging portion (e.g., 550) comprises a plurality of first tabs (e.g., 5501) and a plurality of second tabs (e.g., 5502) provided alternately, wherein the second tab (e.g., 5502) are configured to curve toward the receptacle housing base (e.g., 23) and engage with the recessed portions (e.g., 2301).
38. The electronic system of aspect 37, wherein the first tabs (e.g., 5501) are curved toward the receptacle housing base (e.g., 23) and abut against an edge of the mating side surface (e.g., 230) of the receptacle housing base (e.g., 23).
39. The electronic system of aspect 38, wherein an edge of the mounting side surface (e.g., 220) of the receptacle housing base (e.g., 23) comprises a plurality of second pockets (e.g., 30) provided spaced apart, each of the second pockets (e.g., 30) comprises a second aperture (e.g., 31); and the housing attachment portion (e.g., 51) comprises a plurality of second flat straight extensions (e.g., 510) and a plurality of second curved portions (e.g., 511) provided alternately, the second curved portions (e.g., 511) comprises a second straight portion (e.g., 513) provided in the same plane as the second flat straight extension (e.g., 510) and a second bent portion (e.g., 512) connected to the second straight portion (e.g., 513), and an end surface of the second flat straight extension (e.g., 510) is flush with an end surface of the second bent portion (e.g., 512) of the second curved portion (e.g., 511) in the first direction (e.g., Y) in a direction toward a mounting side of the receptacle housing base (e.g., 23), and wherein when the second conductive member (e.g., 50) is disposed to an outer side of the receptacle housing base (e.g., 23), the second curved portion (e.g., 511) is provided between adjacent two second pockets (e.g., 30), or the second pockets (e.g., 30) is provided between adjacent two second curved portions (e.g., 511), the second flat straight extension (e.g., 510) is inserted through the second aperture (e.g., 31) of the second pocket (e.g., 30) and extends beyond the mounting side surface (e.g., 220) of the receptacle housing base (e.g., 23), and the second flat straight extension (e.g., 510) extending beyond the mounting side surface (e.g., 220) of the receptacle housing base (e.g., 23) has the same dimensions as the dimensions of the receptacle terminal tail (e.g., 212) of the receptacle terminal (e.g., 21) extending beyond the mounting side surface (e.g., 220) of the receptacle housing base (e.g., 23).
40. The electronic system of aspect 39, wherein the second conductive member (e.g., 50) is connected to a second printed circuit board (e.g., 60) by end surfaces of the second flat straight extension (e.g., 510) and the second bent portion (e.g., 512) of the second curved portion (e.g., 511) in the first direction (e.g., Y) in a direction toward the mounting side of the receptacle housing base (e.g., 23).

Having thus described several aspects of several embodiments, it is to be appreciated that various alterations, modifications, and improvements will readily occur to those skilled in the art. Such alterations, modifications, and improvements are intended to be part of this disclosure and are intended to be within the spirit and scope of the invention. While the present teachings have been described in conjunction with various embodiments and examples, it is not intended that the present teachings be limited to such embodiments or examples. On the contrary, the present teachings encompass various alternatives, modifications, and equivalents, as will be appreciated by those of skill in the art.

As an example, although many creative aspects have been described above with reference to vertical connectors, it should be understood that the aspects of the present disclosure are not limited to these. Any one of the creative features, whether alone or combined with one or more other creative features, can also be used for other types of electrical connectors, such as right angle connectors, etc.

Further, though some advantages of the present invention may be indicated, it should be appreciated that not every embodiment of the invention will include every described advantage. Some embodiments may not implement any features described as advantageous. Accordingly, the foregoing description and drawings are by way of example only.

Also, the technology described may be embodied as a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

All definitions, as defined and used, should be understood to control over dictionary definitions, definitions in documents incorporated by reference, and/or ordinary meanings of the defined terms.

In the description of the present disclosure, it is to be understood that orientation or positional relationships indicated by orientation words “front’, “rear,” “upper,” “lower,” “left,” “right,” “transverse direction,” “vertical direction,” “perpendicular,” “horizontal,” “top,” “bottom” and the like are shown based on the accompanying drawings, for the purposes of the case in describing the present disclosure and simplification of its descriptions. Unless stated to the contrary, these orientation words do not indicate or imply that the specified apparatus or clement has to be specifically located, and structured and operated in a specific direction, and therefore, should not be understood as limitations to the present disclosure. The orientation words “inside” and “outside” refer to the inside and outside relative to the contour of each component itself.

For facilitating description, the spatial relative terms such as “on,” “above,” “on an upper surface of” and “upper” may be used here to describe a spatial position relationship between one or more components or features and other components or features shown in the accompanying drawings. It should be understood that the spatial relative terms not only include the orientations of the components shown in the accompanying drawings, but also include different orientations in use or operation. For example, if the component in the accompanying drawings is turned upside down completely, the component “above other components or features” or “on other components or features” will include the case where the component is “below other components or features” or “under other components or features.” Thus, the exemplary term “above” can encompass both the orientations of “above” and “below.” In addition, these components or features may be otherwise oriented (for example rotated by 90 degrees or other angles) and the present disclosure is intended to include all these cases.

It should be noted that the terms used herein are for describing specific embodiments, and are not intended to limit the exemplary embodiments according to the present disclosure. As used herein, an expression of a singular form includes an expression of a plural form unless otherwise indicated. In addition, it should also be understood that when the terms “including” and/or “comprising” are used herein, it indicates the presence of features, steps, operations, parts, components and/or combinations thereof.

The indefinite articles “a” and “an,” as used in the specification and in the claims, unless clearly indicated to the contrary, should be understood to mean “at least one.”

The phrase “and/or,” as used in the specification and in the claims, should be understood to mean “either or both” of the elements so conjoined, e.g., elements that are conjunctively present in some cases and disjunctively present in other cases. Multiple elements listed with “and/or” should be construed in the same fashion, e.g., “one or more” of the elements so conjoined. Other elements may optionally be present other than the elements specifically identified by the “and/or” clause, whether related or unrelated to those elements specifically identified. Thus, as a non-limiting example, a reference to “A and/or B,” when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used in the specification and in the claims, “or” should be understood to have the same meaning as “and/or” as defined above. For example, when separating items in a list, “or” or “and/or” shall be interpreted as being inclusive, e.g., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also enables that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally Including other elements); etc.

In the claims, as well as in the specification above, all transitional phrases such as “comprising,” “including,” “carrying,” “having,” “containing,” “involving,” “holding,” “composed of,” and the like are to be understood to be open-ended, e.g., to mean including but not limited to. For example, a process, method, system, product or device that contains a series of steps or units need not be limited to those steps or units that are clearly listed, instead, it may include other steps or units that are not clearly listed or are inherent to these processes, methods, products or devices. Only the transitional phrases “consisting of” and “consisting essentially of” shall be closed or semi-closed transitional phrases, respectively.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

In the claims, as well as in the specification above, use of ordinal terms such as “first,” “second,” “third,” etc. does not by itself connote any priority, precedence, or order of one element over another or the temporal order in which acts of a method are performed, but are used merely as labels to distinguish one element having a certain name from another element having a same name (but for use of the ordinal term) to distinguish the elements.

What is claimed is:

1. A board-to-board connector comprising:
a housing comprising a base and a plurality of sidewalls extending above the base, the base comprising a plurality of channels extending therethrough, the plurality of channels disposed in an array of rows and columns; and
a plurality of plug terminals held in respective channels of the plurality of channels, each of the plurality of plug terminals comprising a mating end extending above the base, a tail extending below the base and configured for surface mount soldering, and an intermediate portion joining the mating end and the tail and disposed inside a respective channel of the plurality of channels,
wherein mating ends of plug terminals in a row extend above the base to a plurality of heights such that terminals of a mating receptacle connector engage with the plug terminals in the row at different times.

2. The board-to-board connector of claim 1, wherein:
mating ends of plug terminals in a column extend above the base to a same height.

3. The board-to-board connector of claim 1, wherein:
the mating ends of adjacent plug terminals in the row have different heights.

4. The board-to-board connector of claim 1, wherein:
the housing comprises a first sidewall extending in a column direction, and a second sidewall opposing the first sidewall in a row direction and extending in the column direction;
the first sidewall comprises recessed portions on opposite ends in the column direction; and
the second sidewall comprises protruding portions on opposite ends in the column direction.

5. The board-to-board connector of claim 1, wherein:
the plurality of channels are disposed in an array of at least three rows and at least three columns.

6. The board-to-board connector of claim 5, wherein:
each of the plurality of channels comprises a first portion adjacent a mating side surface of the base and having a first width in a row direction, and a second portion adjacent a mounting side surface of the base and having a second width in the row direction greater than the first width.

7. An electronic system comprising:
a first board-to-board connector of claim 1; and
a second board-to-board connector fitting within the plurality of sidewalls of the first board-to-board connector.

8. A board-to-board connector comprising:
a housing comprising a base and a plurality of sidewalls extending above the base, the base comprising a plurality of channels extending therethrough, the plurality of channels disposed in an array of rows and columns; and
a plurality of plug terminals held in respective channels of the plurality of channels, each of the plurality of plug terminals comprising a mating end extending above the base, a tail extending below the base, and an intermediate portion joining the mating end and the tail and disposed inside a respective channel of the plurality of channels, the intermediate portion comprising a curved portion such that the mating end and the tail are offset from each other in a column direction.

9. The board-to-board connector of claim 8, wherein:
mating ends of the plurality of plug terminals in each column extend above the base to a same height; and
mating ends of adjacent plug terminals in each row extend above the base to different heights.

10. The board-to-board connector of claim 8, wherein:
the tails are thinner than the intermediate portions.

11. The board-to-board connector of claim 8, comprising:
a conductive member held by one or more of the plurality of sidewalls of the housing, the conductive member comprising a plurality of inner portions disposed on one or more inner surfaces of the one or more of the plurality of sidewalls and configured to mate with a conductive member of a mating receptacle connector, an outer portion disposed on one or more outer surfaces of the one or more of the plurality of sidewalls and configured to mount to a circuit board, and a connecting portion joining the plurality of inner portions and the outer portion.

12. The board-to-board connector of claim 11, wherein:
each of the plurality of inner portions comprises a frame, and a cantilever having a proximal end corrected to the frame and a distal end curving inwardly for contacting the conductive member of a mating receptacle connector.

13. The board-to-board connector of claim 12, wherein:
the distal end of the cantilever is disposed above the proximal end of the cantilever.

14. The board-to-board connector of claim 12, wherein:
the outer portion comprises a plurality of flat straight extensions configured to mount to the circuit board, and a plurality of curved portions disposed in alternative with the plurality of flat straight extensions and configured to mount to the circuit board.

15. An electrical connector comprising:
a housing comprising a base comprising a plurality of channels extending therethrough, the plurality of channels disposed in an array of rows and columns;
a plurality of terminals held in respective channels of the plurality of channels, each of the plurality of terminals comprising a mating end, a tail extending out of the base, and an intermediate portion joining the mating end and the tail; and
a conductive member held by the housing, the conductive member comprises a plurality of flat straight extensions configured to mount to a circuit board, and a plurality of curved portions alternating with the plurality of flat straight extensions and configured to mount to the circuit board.

16. The electrical connector of claim 15, wherein:
the tails of the plurality of terminals comprise end surfaces configured for mounting to the circuit board;
the plurality of flat straight extensions of the conductive member comprise end surfaces configured for mounting to the circuit board;
the plurality of curved portions of the conductive member comprise end surfaces configured for mounting to the circuit board; and
the end surfaces of the tails of the plurality of terminals, the plurality of flat straight extensions of the conductive member, and the plurality of curved portions of the conductive member are flush with each other.

17. The electrical connector of claim 15, wherein:
the conductive member comprises an outer portion disposed on one or more outer surfaces of the housing and comprising the plurality of flat straight extensions and the plurality of curved portions, and a plurality of inner portions disposed on one or more inner surfaces of the housing and configured to contact a conductive member of a mating connector.

18. The electrical connector of claim 15, wherein:
the base of the housing comprises a mating side surface having a plurality of recessed portions; and
the conductive member comprises a housing engaging portion comprising a plurality of first tabs abutting the mating side surface of the base of the housing, and a plurality of second tabs disposed in respective recessed portions of the plurality of recessed portions of the mating side surface of the base of the housing.

19. The electrical connector of claim 15, wherein:
the mating end of each of the plurality of terminals comprises first and second beams; and
each of the first and second beams comprises a flat portion extending from the intermediate portion, and a curved portion extending from the flat portion and curving toward the curved portion of an other one of the first and second beams.

20. The electrical connector of claim 19, wherein, for each of the first and second beams:
the curved portion extends from the flat portion in a respective helical direction gradually away from the flat portion.
